(19) United States
(12) Patent Application Publication
(10) Pub. No.: US 2011/0107383 A1
(43) Pub. Date: May 5, 2011

(54) METHOD AND SYSTEM FOR CELEBRITY DISPLAY OF WEB FEED CONTENT

(75) Inventors: Scott Barton, Lone Tree, CO (US); Darrin Wesley Harris, Fishers, IN (US)

(73) Assignee: FEEDGAZER, LLC, Fishers, IN (US)

(21) Appl. No.: 12/870,813

(22) Filed: Aug. 28, 2010

Related U.S. Application Data
(63) Continuation-in-part of application No. 12/851,773, filed on Aug. 6, 2010.
Application No. 12/851,773 is a continuation-in-part of application No. 12/299,471, filed on Nov. 4, 2008.
(60) Provisional application No. 60/797,779, filed on May 4, 2006.
(60) Provisional application No. 61/237,777, filed on Aug. 28, 2009.
(60) Provisional application No. 61/237,777, filed on Aug. 28, 2009.

(51) Int. Cl. H04N 7/173

(52) U.S. Cl. 725/109

(57) ABSTRACT

A system displays web feed content on television. A web feed content aggregation system retrieves syndicated web feed content on a web subscription basis, wherein the web feed content aggregation system includes a library that is organized in a web genre tree format including a root node branching to at least one website node, and cataloged by website classes, feed categories and topics. A television content broadcast system broadcasts television content on a television subscription basis. The web feed content aggregation system and the television content broadcast system are interfaced as a function of an account association between a web feed content aggregation subscription account and a television content broadcast subscription account. The system makes additional content available to the user based on content they are watching, have saved for later viewing, have scheduled for future recording, or have searched for.

### REFERENCE TO RELATED APPLICATIONS

The present application is a continuation-in-part of and claims the benefit of U.S. application Ser. Nos. 12/851,773, filed Aug. 6, 2010, pending, and 12/299,471, filed Nov. 4, 2008, pending, which claimed the benefit of International Application No. PCT/US07/68250, filed May 4, 2007, now expired, which claimed the benefit of U.S. Provisional Application No. 60/797,779, filed May 4, 2006, now expired; the present application is also a nonprovisional of and claims the benefit of U.S. Provisional Application No. 61/237,777, filed on Aug. 28, 2009, pending. The entirety of each of these applications is hereby incorporated by reference, and priority is claimed to each.

### FIELD

The present system generally relates to web feed content aggregation systems of any web syndication type (e.g., RSS or Atom) and television content broadcast systems of any TV broadcasting type (e.g., cable or satellite). The present system more specifically relates to an interfacing between the web feed content aggregation system and the television content broadcast system to facilitate a television display of web feed content via an interactive feature of a television or set-top box, such as an on-demand feature, a widget or an application.

### BACKGROUND

Web feed content is the textual/visual/aural content of any web syndication type including, but not limited to, web text content, web image content, web video content, web audio content and web animation content. A web feed content aggregation system is a system structurally configured on a web subscription account basis to retrieve syndicated web feed content (e.g., RSS, Atom and other XML formats) published by web servers.

Television content is the textual/visual/aural content of telecommunication systems including, but not limited to, TV text content, TV image content, TV video content, TV audio content and TV animation content. A television content broadcast system is a system structurally configured to receive and broadcast television content on a television subscription account basis.

Social networking involves a community of individuals and/or groups that facilitates social interaction among its members, including the sharing of information. A social network website is a website structurally configured to facilitate online social interaction among its members on an account subscription basis.

Mobile network operators are telephone companies that provide telephony services for mobile phone subscribers.

### SUMMARY

The present system provides a web feed content interface for facilitating an exchange of web feed content from a web feed content aggregation system to television content broadcast system for purposes of a television display of the web feed content via an interactive feature of a television or a set-top box (e.g., a digital receiver), such as an on-demand feature, a widget or an application.

In one form of the present system, the web feed content aggregation system is operable to facilitate user management of web feed content as a function of a web feed content aggregator subscription account of a user, and the television content broadcast system is operable to facilitate user management of a display of television content as a function of a television content broadcast subscription account of the user. The web feed content interface of the present system is established between the web feed content aggregation system and the television content broadcast system to facilitate an exchange of web feed content between the web feed content aggregation system and the television content broadcast system as a function of an account association between the user's web feed content aggregator subscription account and the television content broadcast subscription account whereby a television display of the web feed content can be managed by the user via an interactive feature of a television or a set-top box, such as an on-demand feature, a widget, or an application.

In one embodiment, the user management of the television display of the web feed content is based on the television content being viewed by the user. For example, in some forms of this embodiment, each celebrity identified in a program currently being viewed by the user or stored for future viewing by the user is utilized to provide web feed content about the celebrity. This web feed content may take the form of specific web page(s) about the celebrity (e.g., a biography web page) and/or bulletins generated from web feed content.

### BRIEF DESCRIPTION OF THE DRAWINGS

FIG. 1 illustrates one embodiment of a web feed content aggregation system, a television content broadcast system and a web feed content interface in accordance with the present system;

FIG. 2 illustrates one embodiment of a television content broadcast system, a television and a web feed content interface in accordance with the present system;

FIG. 3 illustrates one embodiment of a television content broadcast system, a set top box and a web feed content interface in accordance with the present system; and

FIGS. 4A and 4B illustrate a first exemplary embodiment and a second exemplary embodiment of FIGS. 1-3 in accordance with the present system;

FIG. 5 illustrates a third exemplary embodiment of FIGS. 1-3 in accordance with the present system;

FIG. 6 illustrates a fourth exemplary embodiment of FIGS. 1-3 in accordance with the present system;

FIG. 7 illustrates a fifth exemplary embodiment of FIGS. 1-3 in accordance with the present system;

FIG. 8 illustrates an exemplary embodiment of servers illustrated in FIG. 7 in accordance with the present system;

FIG. 9 illustrates an exemplary website content genre tree in accordance with the present system;

FIG. 10 illustrates an exemplary library page in accordance with the present system;

FIG. 11 illustrates an exemplary media root node in accordance with the present system;

FIG. 12 illustrates an exemplary navigation within the media root node illustrated in FIG. 11 in accordance with the present system;

FIG. 13 illustrates an exemplary government/political root node in accordance with the present system;

FIG. 14 illustrates an exemplary education/training root node in accordance with the present system;

FIG. 15 illustrates an exemplary consumer root node in accordance with the present system;

FIG. 16 illustrates an exemplary sports root node in accordance with the present system;

FIG. 17 illustrates an exemplary business/financial root node in accordance with the present system;

FIG. 18 illustrates an exemplary entertainment root node in accordance with the present system;

FIG. 19 illustrates an exemplary science/technology root node in accordance with the present system;

FIG. 20 illustrates an exemplary health root node in accordance with the present system;

FIG. 21 illustrates an exemplary special interest root node in accordance with the present system;

FIGS. 22 and 23 illustrate exemplary embodiments of a web feed bulletin in accordance with the present system;

FIG. 24 illustrates exemplary RSS display synchronization in accordance with the present system;

FIG. 25 illustrates one embodiment of an ad revenue model in accordance with the present system;

FIG. 26 illustrates one embodiment of a multi-display environment in accordance with the present system;

FIG. 27 illustrates one embodiment of a TV-display segment in accordance with the present system of the multi-display environment shown in FIG. 26;

FIG. 28 illustrates one embodiment of an Internet-display segment in accordance with the present system of the multi-display environment shown in FIG. 26;

FIG. 29 illustrates one embodiment of a mobile-display segment in accordance with the present system of the multi-display environment shown in FIG. 26;

FIG. 30 illustrates one embodiment of the multi-display environment shown in FIG. 26 in accordance with the present system;

FIG. 31 illustrates a second exemplary website content genre tree in accordance with the present system;

FIG. 32 illustrates a flowchart representative of a celebrity guide method in accordance with the present system; and

FIG. 33 illustrates exemplary TV icons in accordance with the flowchart illustrated in FIG. 32.

### DETAILED DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which this disclosure relates.

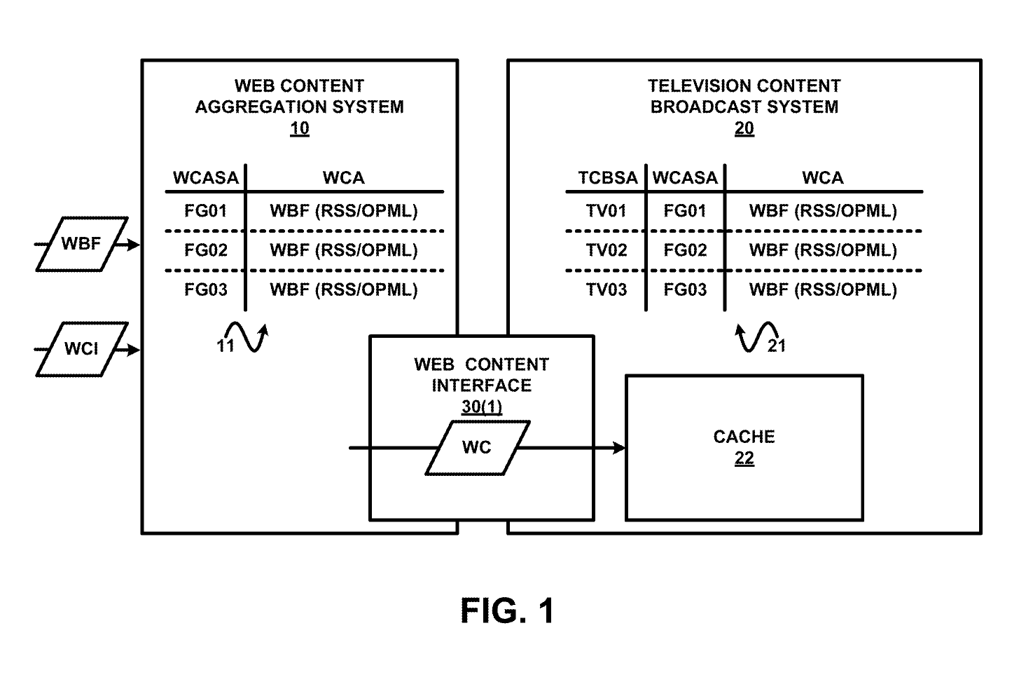

FIG. 1 illustrates a web feed content aggregation system 10 structurally configured to retrieve, on a web subscription account basis, syndicated web feed content of any format (e.g., RSS, Atom and other XML formats) published by any type of web server. Commercial examples of web feed content aggregation system 10 include, but are not limited to, (1) www.feedgazer.com; (2) www.google.com/reader; (3) my.yahoo.com; (4) www.pluck.com; (5) www.newsgator.com; (6) www.rojo.com; (7) www.bloglines.com; (8) www.feedlounge.com; (9) www.netvibes.com; (10) www.newsfirerss.com; (11) www.rrsowl.com; (12) www.rrsexpress.net; (13) www.mozilla.com/en-US/firefox/; (14) www.rssfwd.com; (15) www.raggle.org; and (16) www.planetplanet.org.

While any of the current and future web feed content aggregation systems may be employed in accordance with the inventive principles of the present system, www.feedgazer.com is currently preferred in view of its capability to enable a user to manage individual web feeds of any type based on a web feed content aggregation subscription account established by www.feedgazer.com on behalf of the user and to read in lists of web feeds of any type from additional web feed content aggregation subscription accounts established by third party web feed content aggregation systems on behalf of the user. As such, web feed content aggregation system 10 is shown in FIG. 1 as receiving web feed content WFC for populating a table 11 representing a web feed content aggregation WFCA of web feed content WFC on a web feed content aggregation subscription account WFCASA basis, of which web feed content aggregation subscription accounts FG01, FG02 and FG03 of www.feedgazer.com are shown. As previously described, web feed content WFC can either be directly subscribed by the user via www.feedgazer.com (via the “RSS” format) and/or indirectly subscribed by the user via one or more third party web feed content aggregation systems (via the “OPML” format).

FIG. 1 further illustrates a television content broadcast system 20 structurally configured to receive and broadcast television content on a user subscription account basis. Commercial examples of television content broadcast system 20 include, but are not limited to, cable television providers such as (1) Insight Communications; (2) Comcast; (3) Adelphia; (4) Austar; (5) Bright House Networks; (6) CableOne; (7) Cable TV Hong Kong; (8) Cablevision (US); (9) Cablevision (Canada); (10) Canal Digital; (11) Charter; (12) Champion Broadband; (13) Cogeco; (14) Columbus Communications; (15) Com Hem; (16) Cox; (17) Eastlink; (18) Foxtel; (19) GCI; (20) Global Destiny; (21) Globosat; (22) Kabel Deutschland; (23) Knology; (24) MASTV; (25) MCV Broadband; (26) Mediacom; (27) Midcontinent Communications; (28) Millennium Digital Media; (29) Neighbourhood Cable; (30) Net Brasil; (31) NTL; (32) Ono; (33) Optus; (34) Persona; (35) RCN; (36) Rogers; (37) Satview Broadband Ltd; (38) Service Electric; (39) SkyCable; (40) Shaw; (41) StarHub CableTV; (42) Suddenlink; (43) TDC; (44) Tele2; (45) TelstraClear InHomeTV; (46) Time Warner; (47) TransACT; (48) TV Cabo; (49) Videotron; (50) Virgin Media; (51) WOW! Internet Cable Phone; and (52) WightCable.

Further commercial examples of television content broadcast system 20 include, but are not limited to, satellite television providers such as (1) AlphaStar; (2) ART; (3) Astro; (4) Astro Nusantara; (5) Athina Sat; (6) Austar; (7) Bell ExpressVu; (8) Canal Digital; (9) CanalSat; (10) Cyfra+; (11) DialogTV; (12) Digital+; (13) Digiturk; (14) DirecTV; (15) Dish Network| Dish TV; (16) DStv; (17) Euro1080; (18) Freesat; (19) Freesat from Sky; (20) FreeView (NZ); (21) Foxtel; (22) GlobeCast World TV; (23) Globosat; (24) Glorystar; (25) Home2US; (26) NTV Plus; (27) NOVA Cyprus; (28) NOVA Greece; (29) Orbit; (30) Premiere; (31) PrimeStar; (32) SelecTV; (33) Showtime Arabia; (34) Sky Angel; (35) Sky Digital; (36) SKY Italia; (37) Sky PerfecTV!; (38) Sky TV (NZ); (39) Star Choice; (40) STAR TV; (41) Tata Sky; (42) TPS; (43) TV Cabo; (44) UBI World TV; (45) Viasat; (46) Voom; and (47) WOWOW.

While any of the current and future television content broadcast systems may be employed in accordance with the inventive principles of the present system, such systems having or capable of having an interactive feature (e.g., on-demand or a widget) are preferred in view of the ease and convenience a user would have in managing a television display of web feed content based on a remote control using these features as known in the art.

FIG. 1 further illustrates a web feed content interface 30(1) structurally configured to exchange web feed content WFC between web feed content aggregation system 10 and television content broadcast system 20 based on an account association of each web feed content aggregator subscription account (“WFCASA”) of system 10 to a television content broadcast subscription account (“TCBSA”) of system 20 as represented by a table 21, in which television content broadcast subscription accounts TV01, TV02 and TV03 for example are shown associated with respective web feed content aggregator subscription accounts FG01, FG02 and FG03 of www.feedgazer.com for example.

In view of the numerous and variety of possible commercial implementations of systems 10 and 20 in practice, the present system does not impose any limitations nor any restrictions as to the manner by which web feed content interface 30(1) is structurally configured to exchange and format web feed content WFC between systems 10 and 20.

In one embodiment, web feed content interface 30(1) is structurally configured as a database manager of any type operable to exchange web feed content WFC between systems 10 and 20 in a format suitable for the transmission via the world wide web. Alternatively or concurrently, web feed content interface 30(1) is structurally configured as a database manager of any type operable to exchange web feed content WFC between systems 10 and 20 in a format suitable for the broadcast of the web feed content WFC in a television content format. For either embodiment, television content broadcast system 20 preferably, although not necessarily, employs a cache 22 for storing a portion or an entirety of web feed content WFC for each individual television content broadcast subscription account TCBSA.

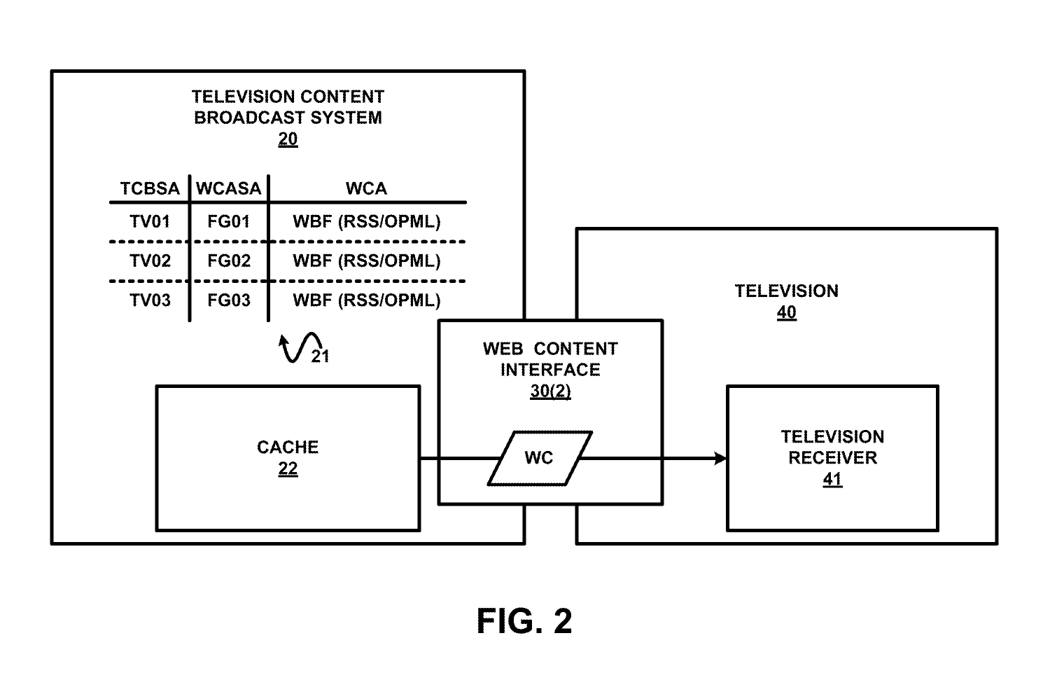

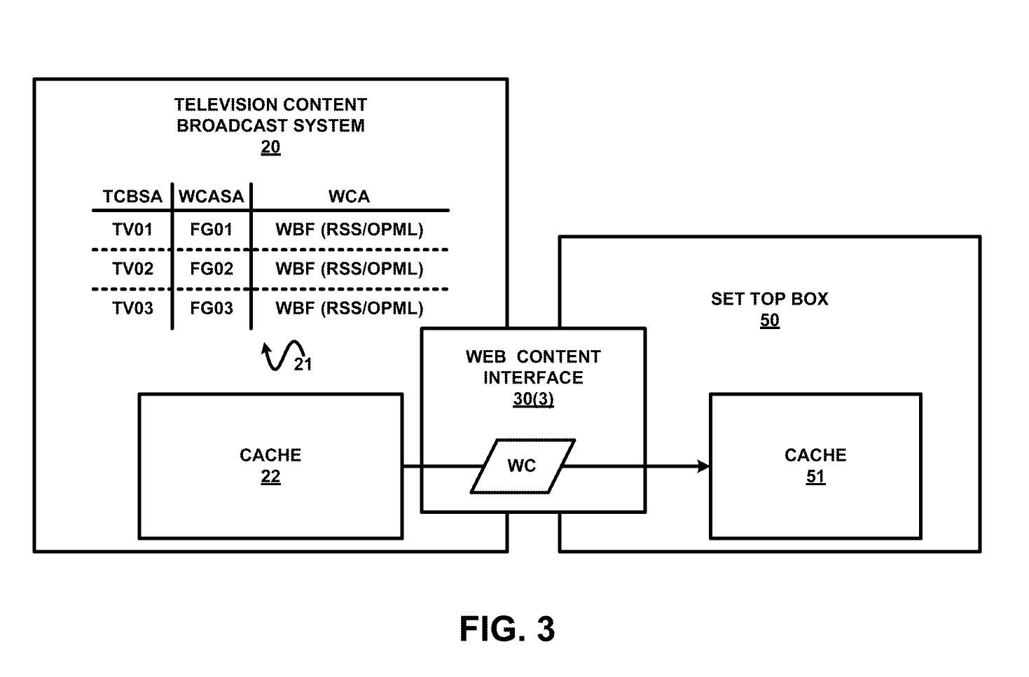

Web feed content interface 30(1) is considered a front end interface. To further enable television display of the web feed content WFC that is managed by a user of a television content broadcast subscription account TCBSA, a back end web feed content interface 30(2) is structurally configured to exchange web feed content WFC between television content broadcast system 20 and either a television 40 via its television receiver 41 (e.g., a cable or Internet based receiver) as shown in FIG. 2 or a set top box 50 via a cache 51 as shown in FIG. 3. In either case, in view of the number and variety of possible commercial implementations of system 20, television 40 and set top box 50 in practice, the present system does not impose any limitations nor any restrictions as to the manner by which web feed content interface 30(2) is structurally configured to exchange and format web feed content WFC between system 20 and television 40 and between system 20 and set top box 50.

In one embodiment, web feed content interface 30(2) is structurally configured as an interactive feed manager (e.g., on-demand or a widget) operable to enable a user of the television content broadcast subscription account TCBSA to control a display of the web feed content WFC via a remote control whereby television content broadcast system 20 is responsive to remote control commands to provide the web feed content WFC interactively in either a world wide web format and/or in a television content format to television receiver 41 or to set top box 50 based on the account association.

In practice, the structural configuration of interfaces 30 is within the skill of those having ordinary skill in the art of web and television formatting and communication protocols, particularly those having skill in database management, video on demand and widget programming.

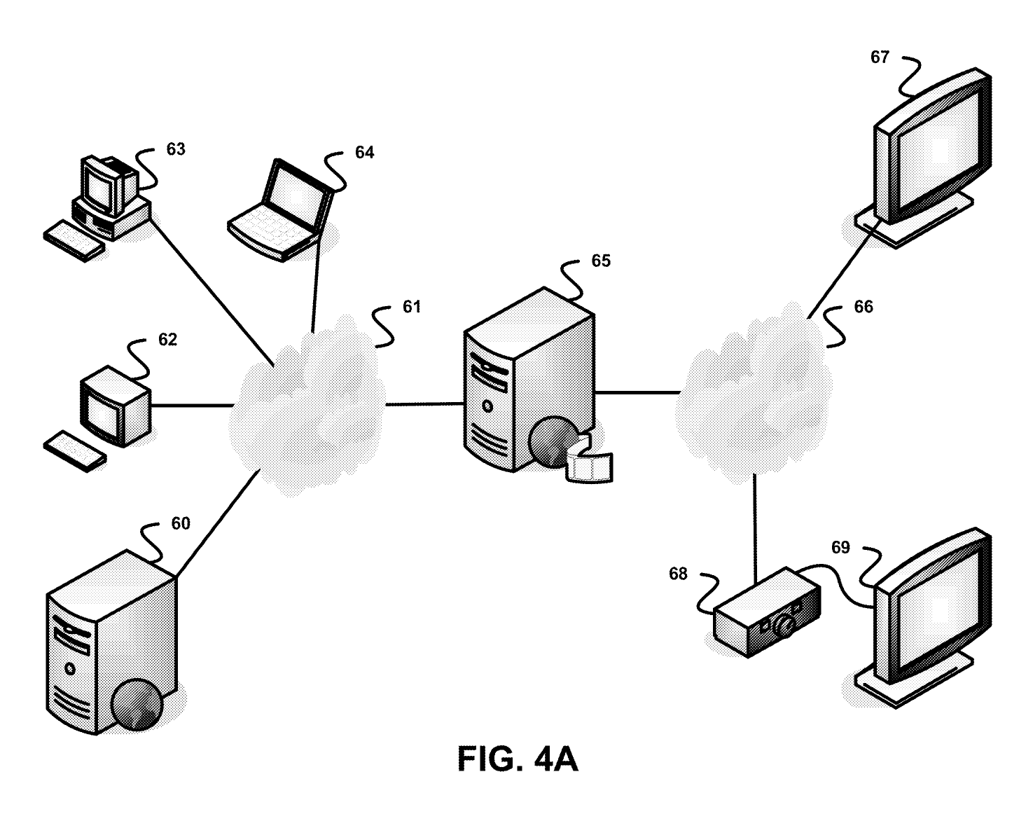

FIG. 4A illustrates an exemplary embodiment of FIGS. 1-3 with a web server 60 serving as web feed content aggregation system 10 (FIG. 1) and a streaming/downloading media server 65 serving as a feed on demand component of television content broadcast system 20 (FIGS. 1-3). A user can utilize a PC 63, a workstation 64, a laptop 65 or the like to manage a retrieval of web feed content WFC by server 60 via an internet network 61 of any type from other web servers (not shown) based on the user's web feed content aggregation subscription account WFCASA (e.g., account FG01 of FIGS. 1-3). Front end web feed content interface 30(1) (FIG. 1) is installed on server 60, installed-on server 65 or distributed among servers 60 and 65 to provide web feed content WFC retrieved by server 60 to server 65 on a web feed content aggregation subscription account WFCASA basis.

Back end web feed content interface 30(2) (FIGS. 2 and 3) is installed in server 65, installed in a television 67 and a set top box 68, or distributed among server 65, television 67 and set top box 68 to provide the web feed content WFC received by server 65 via a telecommunications network 66 of any type in either a world wide web format and/or in a television content format to television 67 or a television 69 via set top box 68 based on an account association of the user's web feed content aggregation subscription account WFCASA (e.g., account FG01 of FIGS. 1-3) and television content broadcast subscription account TCBSA (e.g., account TV01 of FIGS. 1-3).

FIG. 4B illustrates an alternative embodiment of FIG. 4A with web server 60 being connected via an intranet network 70 of any type to streaming/downloading media server 65.

Referring to FIGS. 4A and 4B, servers 60 and 65 can represent an actual physical implementation of the present system or a logical domain representation of the present system. Furthermore, a video on demand system can be integrated in server 65 with a feed on demand system in accordance with the present system via a hard or soft switch. Commercial examples of video on demand systems include, but are not limited to, Akimbo, iN Demand and SeaChange International.

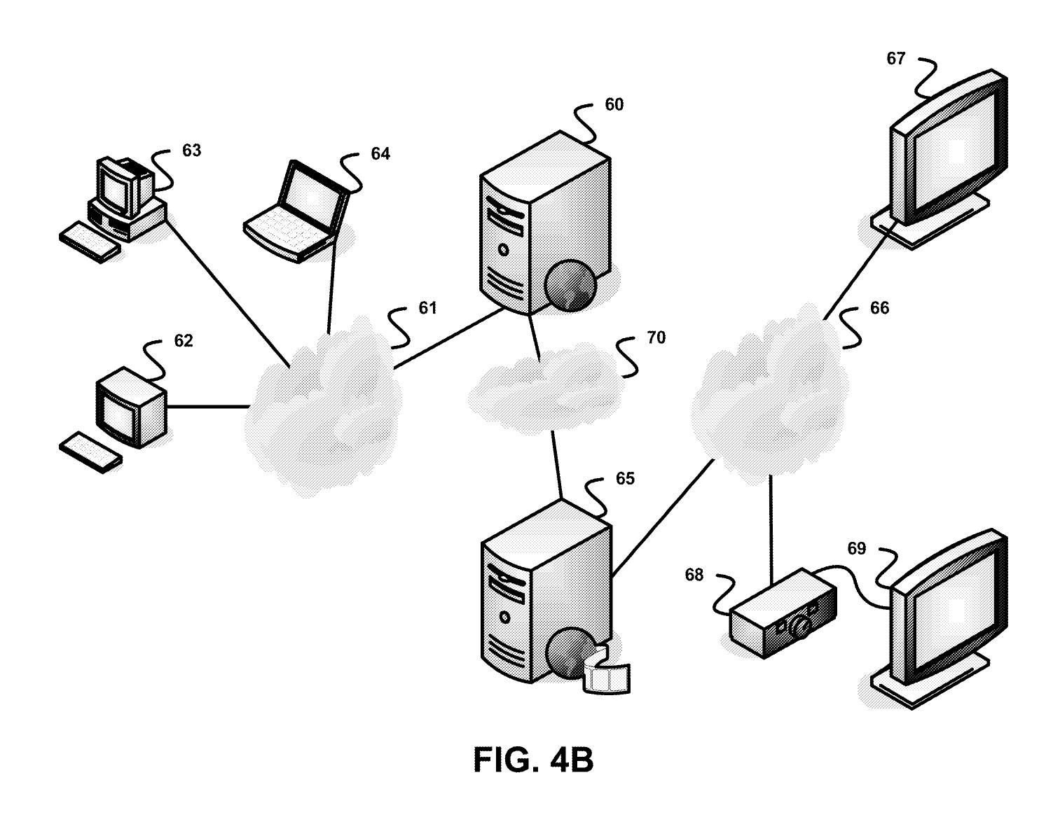

For example, FIG. 5 illustrates a logical domain 80 having a web feed content aggregation system (not shown) and a television content broadcast system (not shown) that facilitates an access management via an interne 85 of web feed content (e.g., subscribed RSS feeds) and targeted advertisements via a web client 87 for purposes of allowing an on-demand display of web feed content on a television 88 and targeted advertisements via a cable/satellite television network 86. To this end, the content systems of domain 80 employ a database management of a web feed content catalog 81 and a targeted advertisement inventory 82 as a function of an account association of a web feed aggregator account directory 83 and a cable/satellite television account directory 84.

Specifically, web feed content catalog 81 encompasses a web feed directory table and a table for each web feed on a syndicated feed item basis. The web feed directory table is designed on a feed category basis whereby the web feed directory table is updated upon the discovery of a new web feed source fitting within a category and a table for a particular listed web feed is updated each time a listed web feed syndicates a new web feed item.

Targeted advertisement inventory 82 encompasses an advertisement directory table and a table for each subscriber of domain 80 on a solicited targeted basis. Thus, any advertisement installed in domain 80 (e.g., uploaded, downloaded or streamed) is tracked in the directory table and communicated to each subscriber for purposes of facilitating a selection of viewing the advertisement by each subscriber on a item or category basis.

Web feed aggregator account directory 83 and cable/satellite television account directory 84 encompass a listing of each subscriber to domain 80 for purposes of facilitating a viewing of subscripted web feed content via client 87 or television 88, respectively. The account association of each directory 83 and 84 enables the viewing to be accomplished in a cooperative manner between the content systems that monitors when and where each feed items has been viewed by each subscriber, saves viewed feed items at the discretion of a subscriber and further dynamically updates the viewing of feed items based on any change in a web feed subscription by a subscriber.

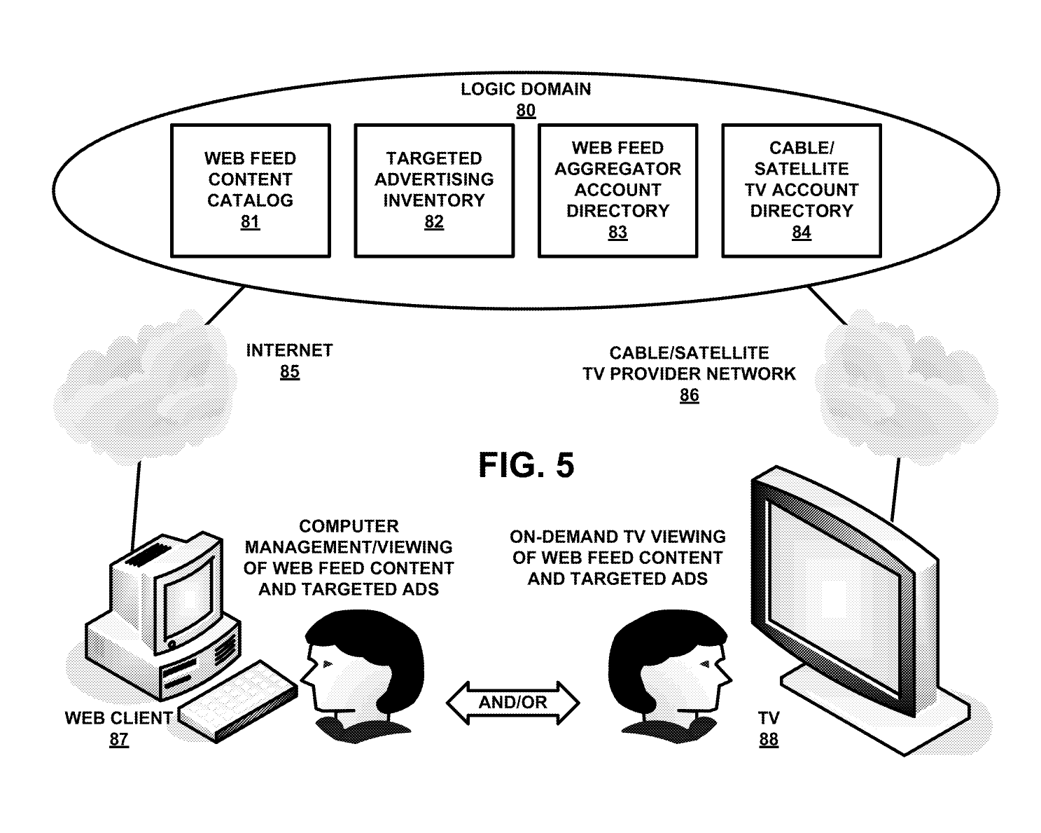

FIG. 6 illustrates an account association of a web subscription account 91 of a web feed content (“WFC”) aggregation system 90 with a television subscription account 101 of a digital receiver 100 of a television feed content (“TFC”) system. This account association enables a viewer to either (1) view web feed content in web format from an aggregator library 92 via the Internet 110 or (2) view the web feed content in TV format from the aggregator library 110 via a cable/satellite network 111 or alternatively the Internet 110. In the case of an Internet viewing of the web feed content, a web client 120 is used to access the aggregator library 92 as currently practiced today with known aggregators. In the case of a cable/satellite TV viewing of the web feed content, a remote control of the digital receiver 100 is used to activate an interactive feature 102 of the digital receiver 100 (e.g., an on-demand feature, a widget or an application.) to access the aggregator library 92. The aggregator library 92 is a library of websites having web feed content that is organized in a hierarchy that facilitates a viewer management of a personal portfolio of such websites selected from the aggregator library 92. The hierarchy has a public version designed on a website genre tree for viewers having minimal; if any, experience with websites having web feed content. The hierarchy further has one or more private versions generated on a feed category basis or a website genre tree for viewers having extensive experience with websites having web feed content. Additionally, system 90 synchronizes viewing between the Internet and cable/satellite viewing channels 110/111 to ensure new web feed content is being presented at each viewing and provides a chronicle service for storing links to the web feed content.

For purposes of the present system, the term “feed category basis” is broadly defined herein as any group listing of individual web feeds by a categorization of the web feeds as opposed to a genre of the associated websites. Examples include, but are not limited to, a football folder listing of all football feed subscriptions irrespective of the genre of the associated websites or a financial folder listing all financial feed subscriptions irrespective of the genre of the associated website.

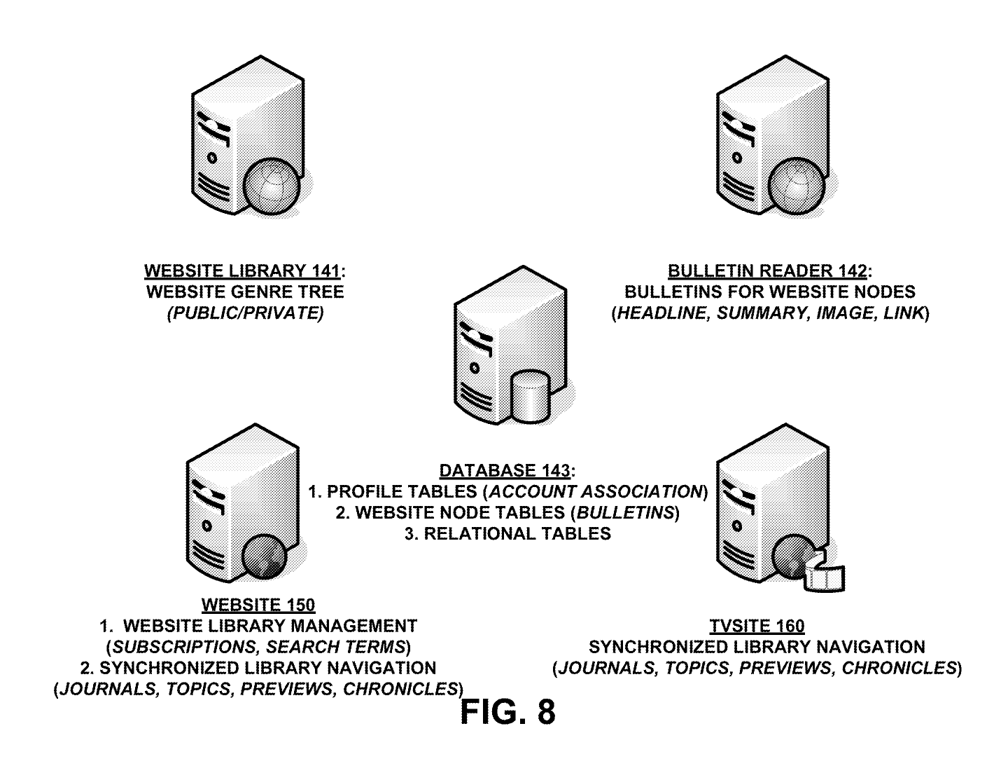

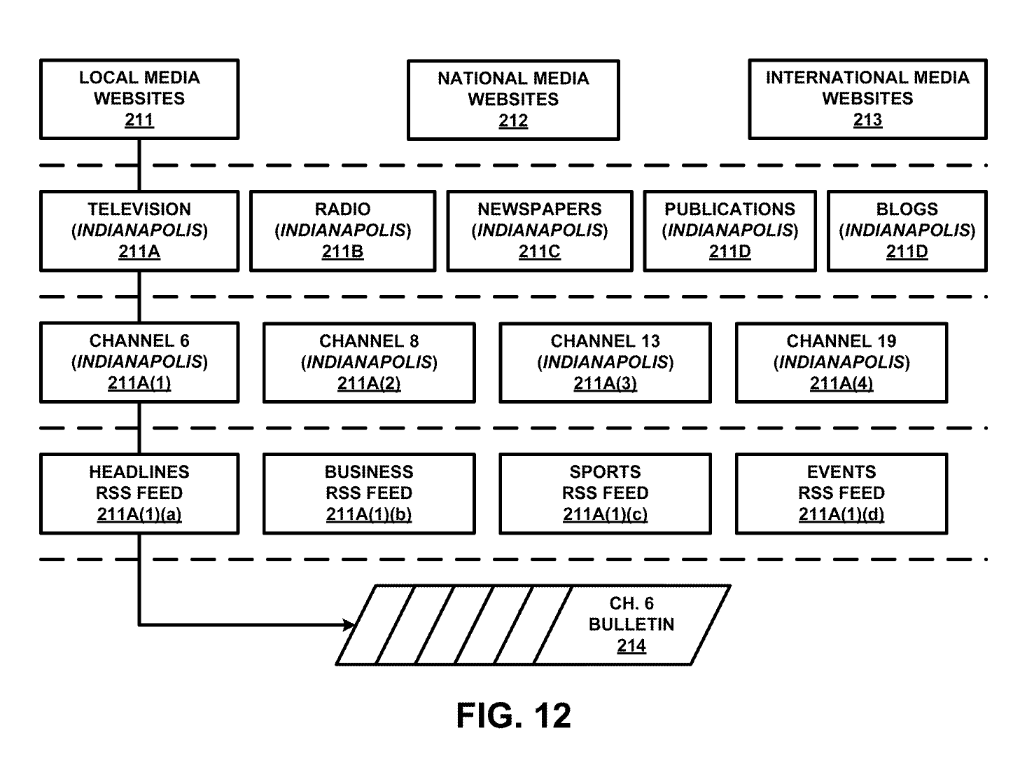

By comparison, for purposes of the present system, the term “web genre tree” is broadly defined herein as having root nodes branching to one or more website nodes, with each website node listing one or more individual websites on the basis of a genre of the corresponding root node and with each listed website listing all of its associated web feeds. Examples are provided herein in connection with the description of FIGS. 9-21.

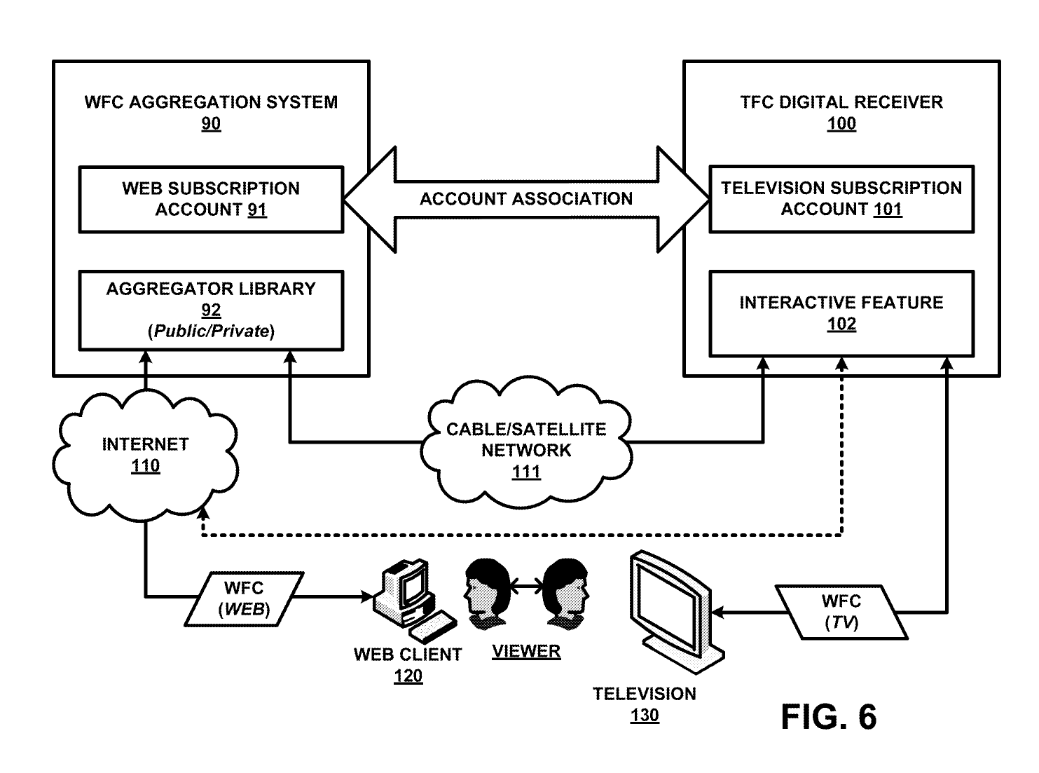

FIG. 7 illustrates a commercial incorporation of the aggregator system into an interactive feature of a cable/satellite television provider. As shown FIG. 7, a web content aggregation system 140 employs a website library 141, a bulletin reader 142 and a database 143 for managing and displaying a vast number of web feeds on behalf of the subscribers of the cable/satellite television provider as well as non-subscribers. Specifically, a website 150 will facilitate subscriber/non-subscriber access to system 140 via the internet 110 whereby banner/video advertising from a web ad server 151 will generate ad revenue from the subscribers as well as non-subscribers accessing website 140. A TV site 160 will facilitate viewer access to system 140 via the cable/satellite network 111 or alternatively internet 110 whereby banner/video advertising from a TV Ad Server 161 will generate ad revenue from the subscribers. Optionally, a promotion server or servers (not shown) may substitute for and/or supplement ad server 151 and/or ad server 161 to provide promotion of various websites to the subscribers as well as nonsubscribers.

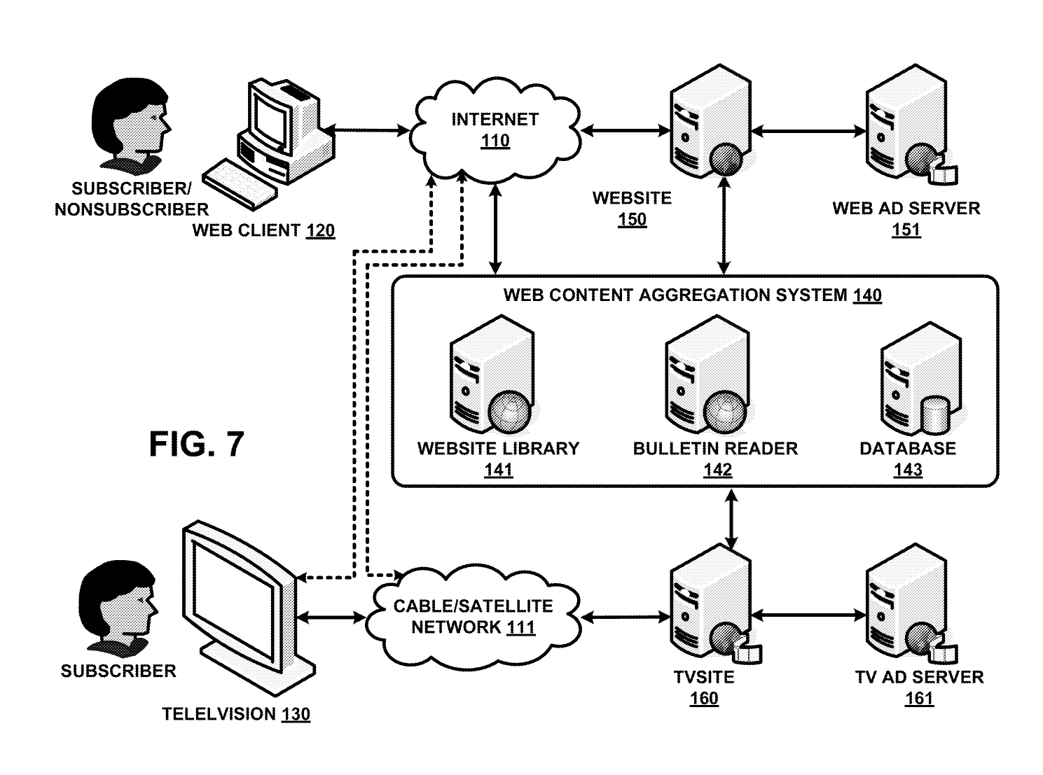

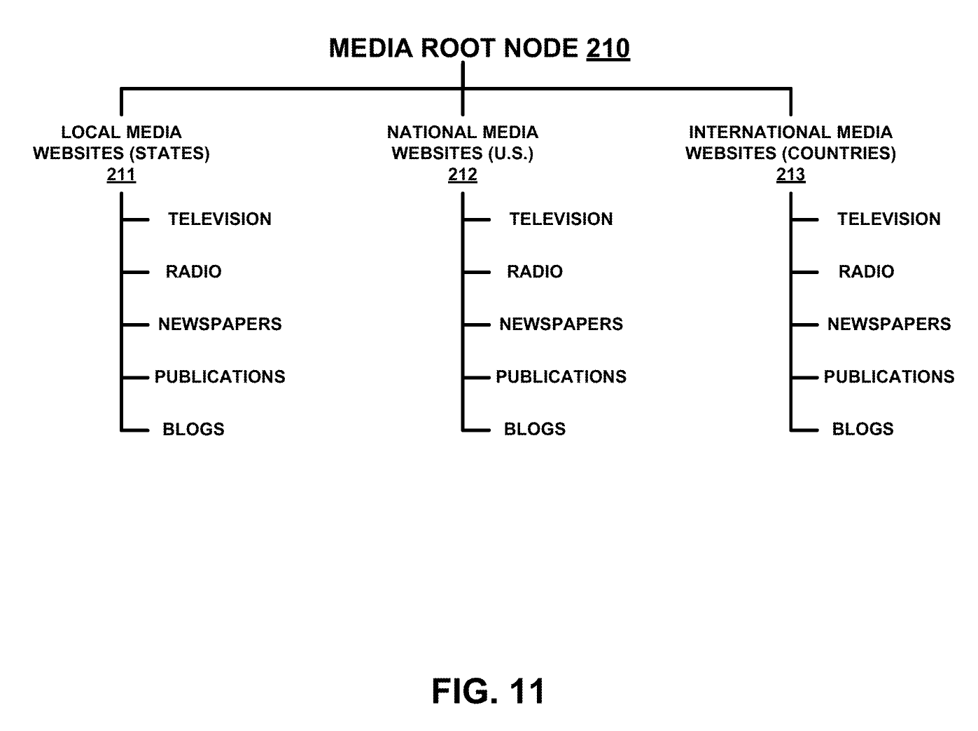

FIG. 8 illustrates servers 141-143, 150 and 160 in more detail. Specifically, web library server 141 is structurally configured with a web genre tree, such as, for example, a web genre tree 200 shown in FIG. 9. Web genre tree 200 has twelve (12) root nodes 210-330. A media root node 210 lists all websites primarily designed for the reporting of a variety of news subjects (e.g., television, radio, newspapers, and publications) and may be further branched into local websites node 211, national websites node 212 and international websites node 213 as shown in FIG. 11.

A media root node 210 lists all websites primarily designed for the reporting of a variety of information from various sources (e.g., television, radio, newspapers, publications, blogs) and may be further branched into local websites node 211, national websites node 212 and international websites node 213 as shown in FIG. 11. An example includes, but is not limited to, www.cnn.com listed under television for national website node 212.

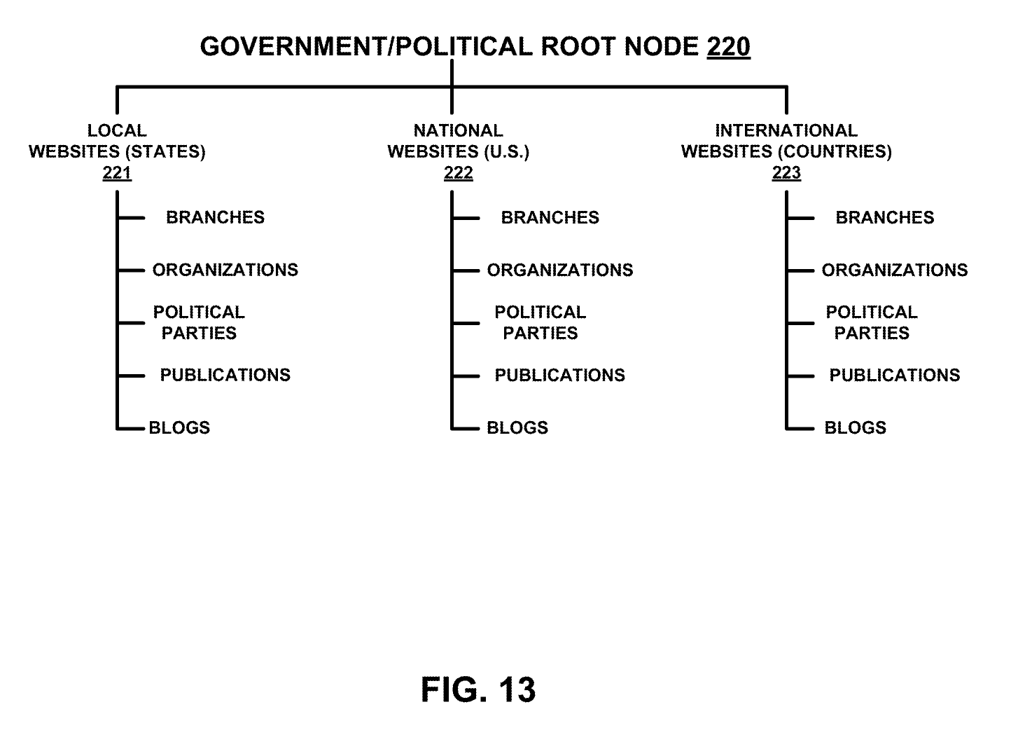

A government/political root node 220 lists all websites primarily designed for the reporting of political information from various sources (e.g., government branches, organizations, political parties, publications, and blogs) and may be further branched into local websites node 221, national websites node 222 and international websites node 213 as shown in FIG. 13. An example includes, but is not limited to, www.whitehouse.gov listed under branches for national website node 222.

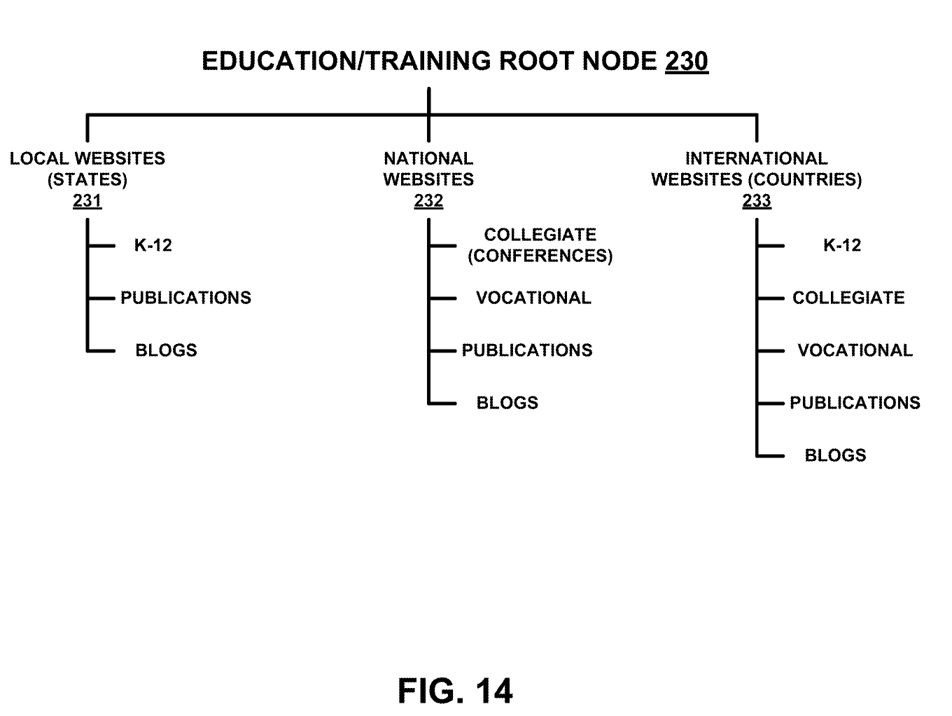

An educational/training root node 230 lists all websites primarily designed for the reporting of educational/training information from various sources (e.g., K-12, collegiate, vocational, publications, blogs) and may be further branched into local websites node 231, national websites node 232 and international websites node 233 as shown in FIG. 14. An example includes, but is not limited to, www.purdue.edu listed under collegiate for national website node 232.

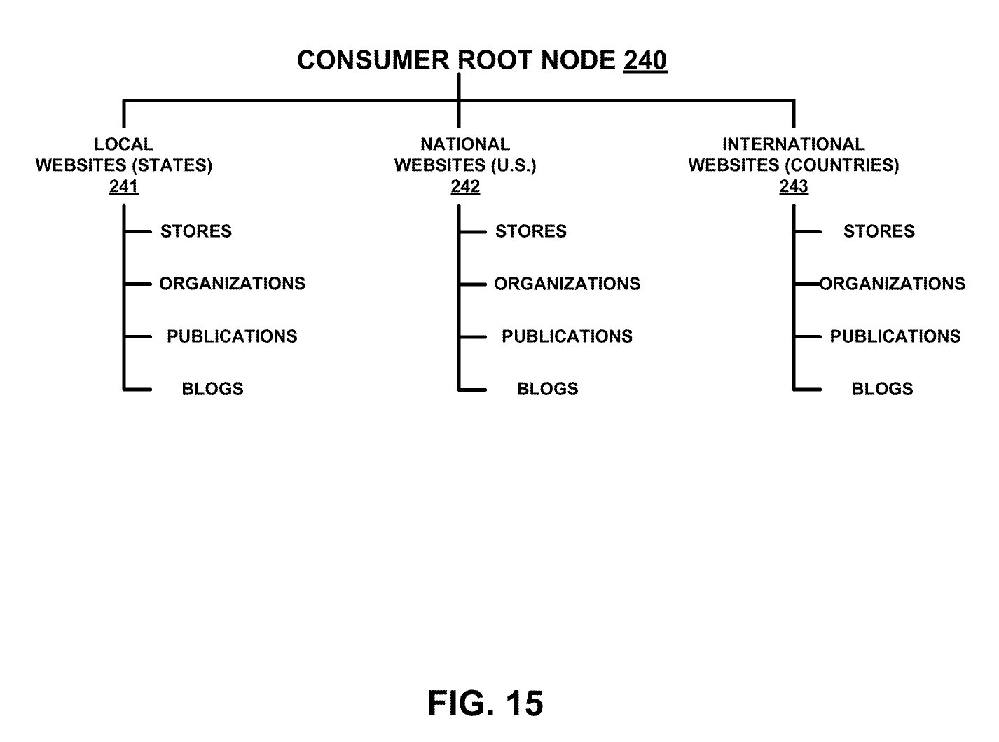

A consumer root node 240 lists all websites primarily designed for the online sale of products and services from various sources (e.g., stores, organizations, publications and blogs) and may be further branched into local websites node 241, national websites node 242 and international websites node 243 as shown in FIG. 15. An example includes, but is not limited to, www.dell.com listed under television for national website node 242.

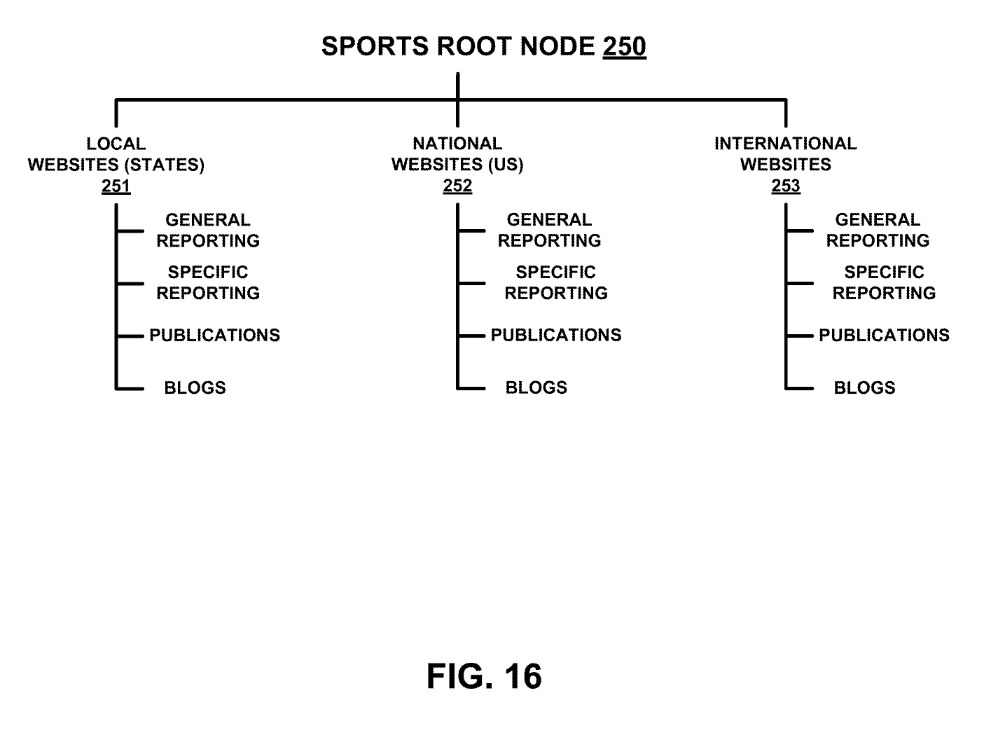

A sports root node 250 lists all websites primarily designed for the reporting of sports information from various sources (e.g., general sports reporting, specific sports reporting, publications and blogs) and may be further branched into local websites node 251, national websites node 252 and international websites node 253 as shown in FIG. 16. An example includes, but is not limited to, www.espn.com listed under national website node 252.

A video root node 260 lists all websites primarily designed for the viewing of videos from public sources or privates sources. An example includes, but is not limited to, www.youtube.com.

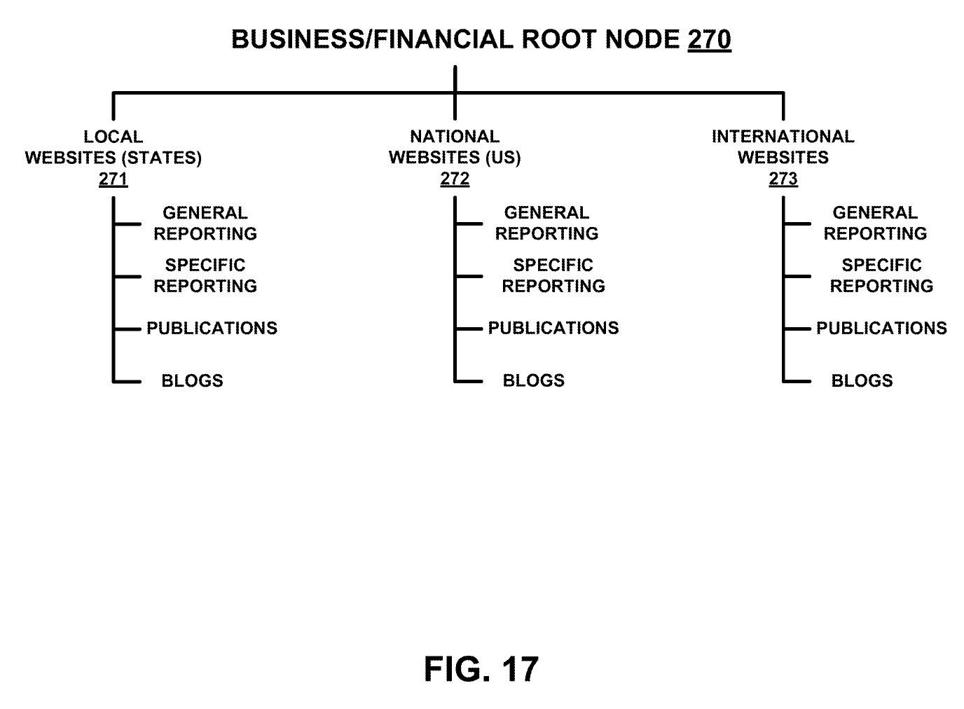

A business/financial root node 270 lists all websites primarily designed for the reporting of business/financial information from various sources (e.g., general business/financial reporting, specific business/financial reporting, publications and blogs) and may be further branched into local websites node 271, national websites node 272 and international websites node 273 as shown in FIG. 17. An example includes, but is not limited to, www.tmz.com listed under national website node 272.

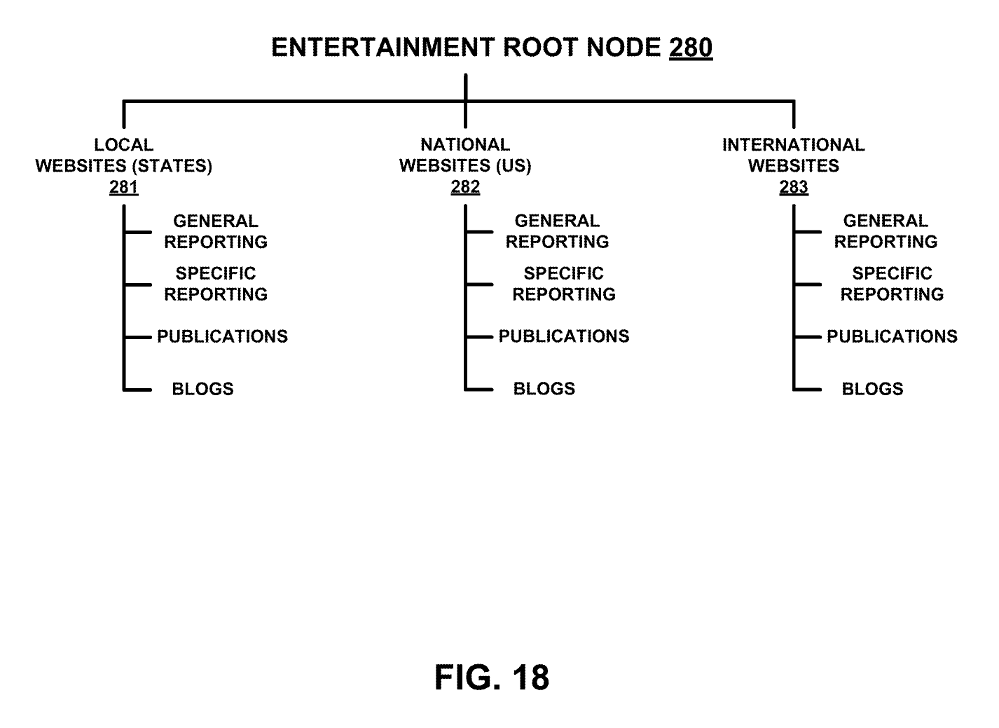

An entertainment root node 280 lists all websites primarily designed for the reporting of entertainment information from various sources (e.g., general entertainment reporting, specific entertainment reporting, publications and blogs) and may be further branched into local websites node 281, national websites node 282 and international websites node 283 as shown in FIG. 18. An example includes, but is not limited to, www.tmz.com listed under national website node 282.

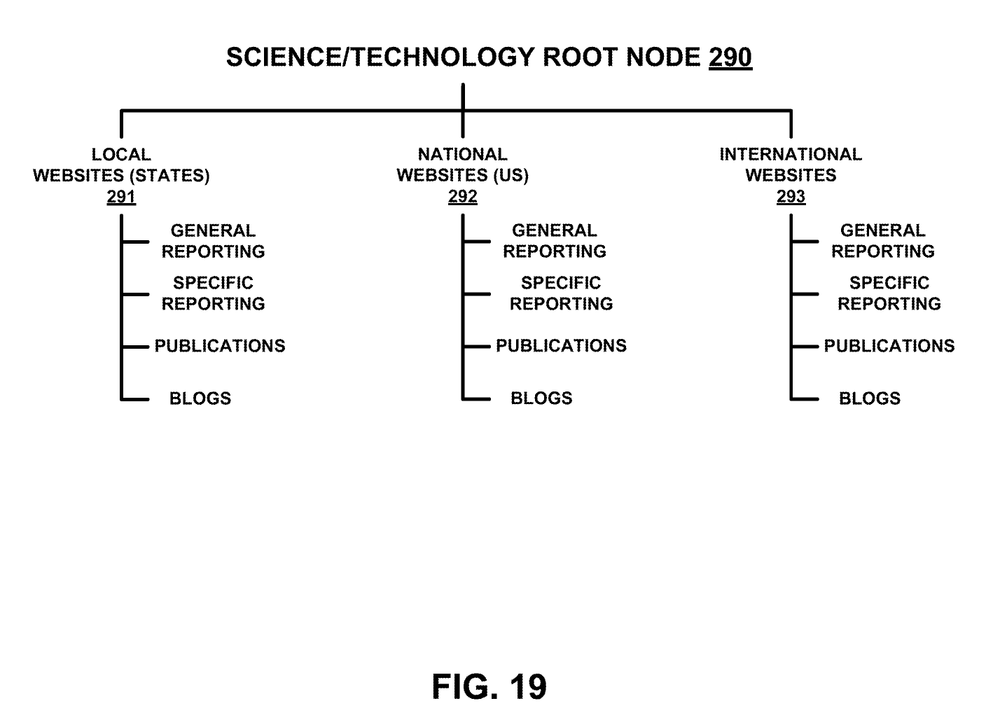

A science/technology root node 290 lists all websites primarily designed for the reporting of scientific and technological information from various sources (e.g., general science/technology reporting, specific science/technology reporting, publications and blogs) and may be further branched into local websites node 291, national websites node 292 and international websites node 293 as shown in FIG. 19. An example includes, but is not limited to, www.space.com listed for national website node 292.

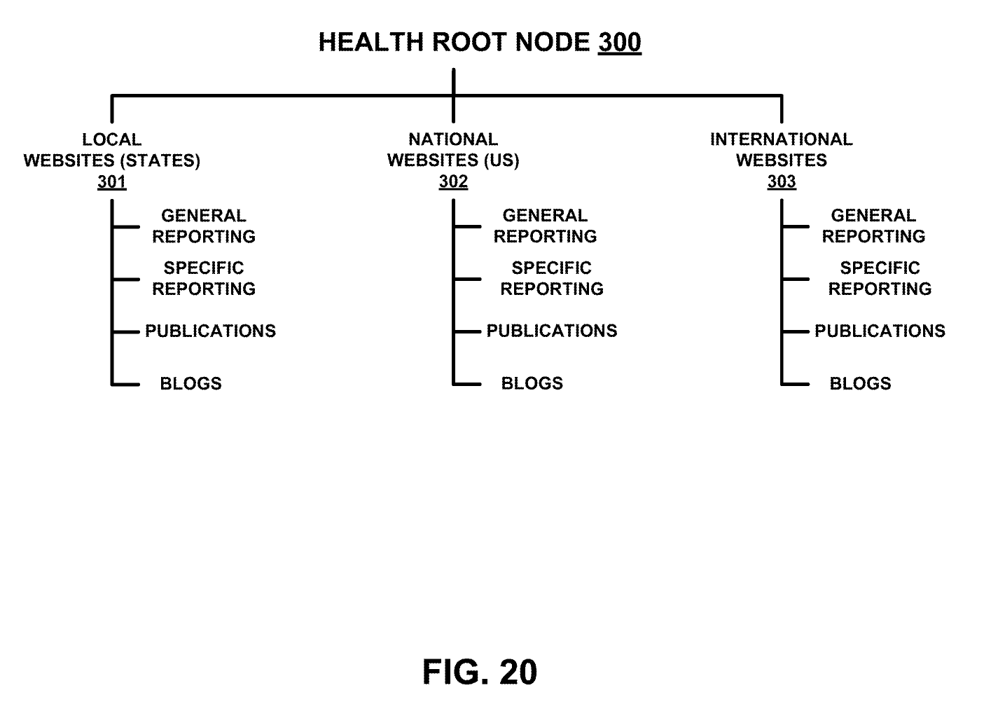

A health root node 300 lists all websites primarily designed for the reporting of health information from various sources (e.g., general health reporting, specific health reporting, publications and blogs) and may be further branched into local websites 301, national websites 302 and international websites 303 as shown in FIG. 20. An example includes, but is not limited to, www.webmd.com listed under national website node 302.

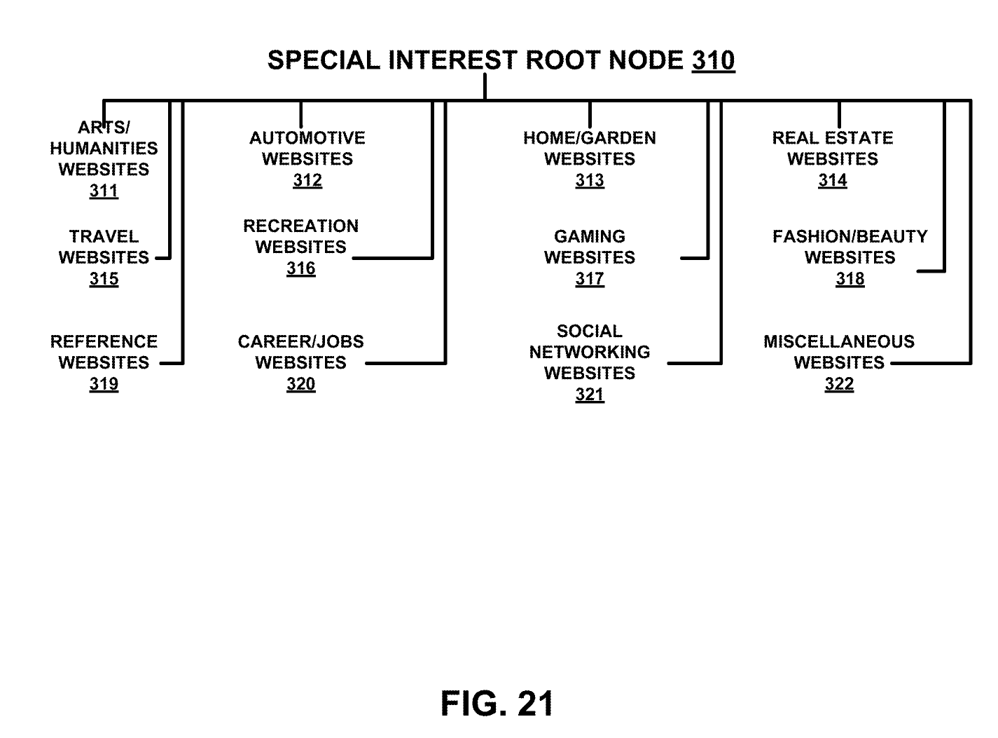

A special interest root node 310 lists all websites primarily designed for a particular interest from various sources, and may be further branched into arts/humanities websites 311, automotive websites 312, home/garden websites 313, real estate websites 314, travel websites 315, recreation websites 316, gaming websites 317, fashion/beauty websites 318, reference websites 319, career/job websites 320, social networking websites 321 and miscellaneous websites 322 as shown in FIG. 21.

A personal root node 330 lists all websites primarily designed for a selective group for a particular purpose, such as, for example, each website having a personal login to view web feed content.

In practice, website library server 141 may employ website genre tree 100 for each user of system 140 as a public library and may allow for a modification of website genre tree 100 to some extent by users to form private libraries.

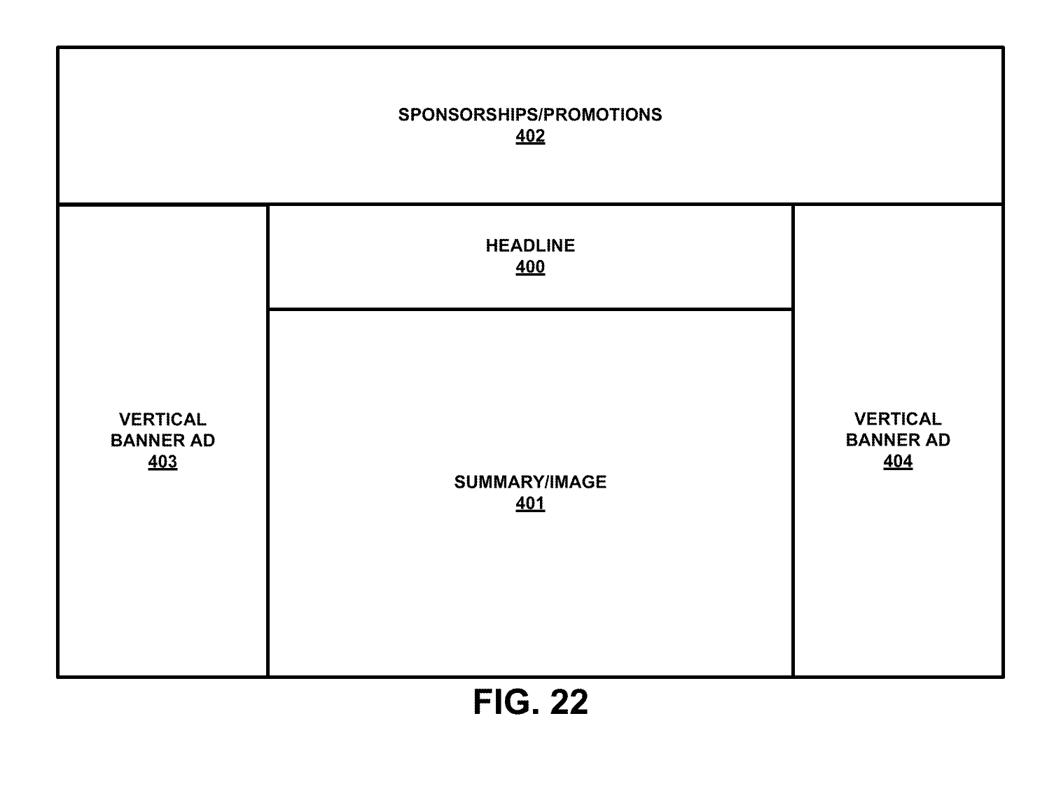

Referring to FIG. 8, bulletin reader server 142 is structurally configured to create a bulletin for each web feed item in accordance with each website node of web genre tree 200. Each bulletin will have a headline and summary/image derived from the web feed item (e.g., RSS feed), such as, for example, headline 400 and summary/image 401 shown in FIGS. 22 and 23. Optionally, each bulletin may include banner ads and/or sponsorships/promotions, such as, for example, sponsorships/promotions 402 and banner ads 403/404 shown in FIG. 22, and banner ad 405 and sponsorships/promotions 406/407 shown in FIG. 23.

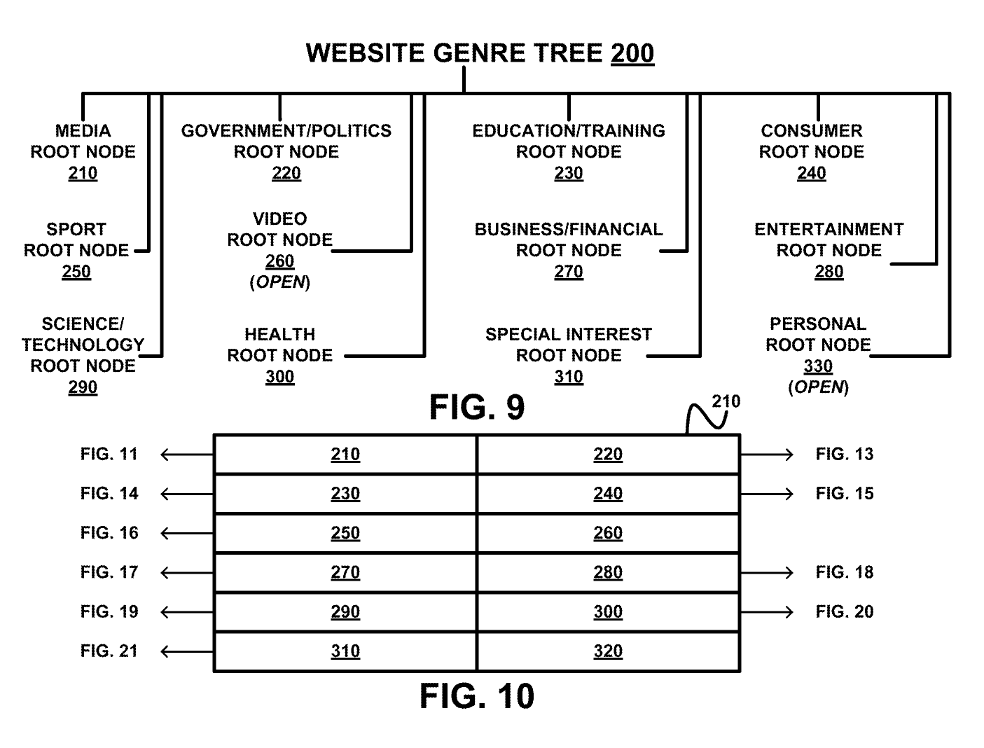

For management and display purposes, website genre tree 200 may be organized in a manner that facilitates navigation within tree 200 via a mouse or a remote control, such as, for example, a page 210 shown in FIG. 10.

An exemplary display navigation as shown in FIG. 11 involves a navigation through media root node 210. Specifically, as shown, sequential selection via a mouse or remote control of local websites node 211 to television websites node 211(A) to Channel 6 website 211(A)(1) to headlines RSS feeds 211(A)(1)(a) results in Channel 6 bulletins for display.

Referring to FIG. 8, database server 143 is structurally configured to manage all necessary database tables for the account association as well as facilitating a management and a display of webs feed content. For example, database server 143 may store profile tables for the account association as well as any other pertinent user information (e.g., login). Further, database server 143 may store website node tables for associated bulletins being generated by server 141. Database server 143 may also include any relational tables as needed.

Still referring to FIG. 8, website server 150 is structurally configured to facilitate a user selection of subscriptions to web feeds of various websites in accordance with a scripted navigation through the website genre tree. Website server 150 is further structurally configured to facilitate a user search of one or more terms within the headlines and summary of each bulletin or specific set or sets of bulletins.

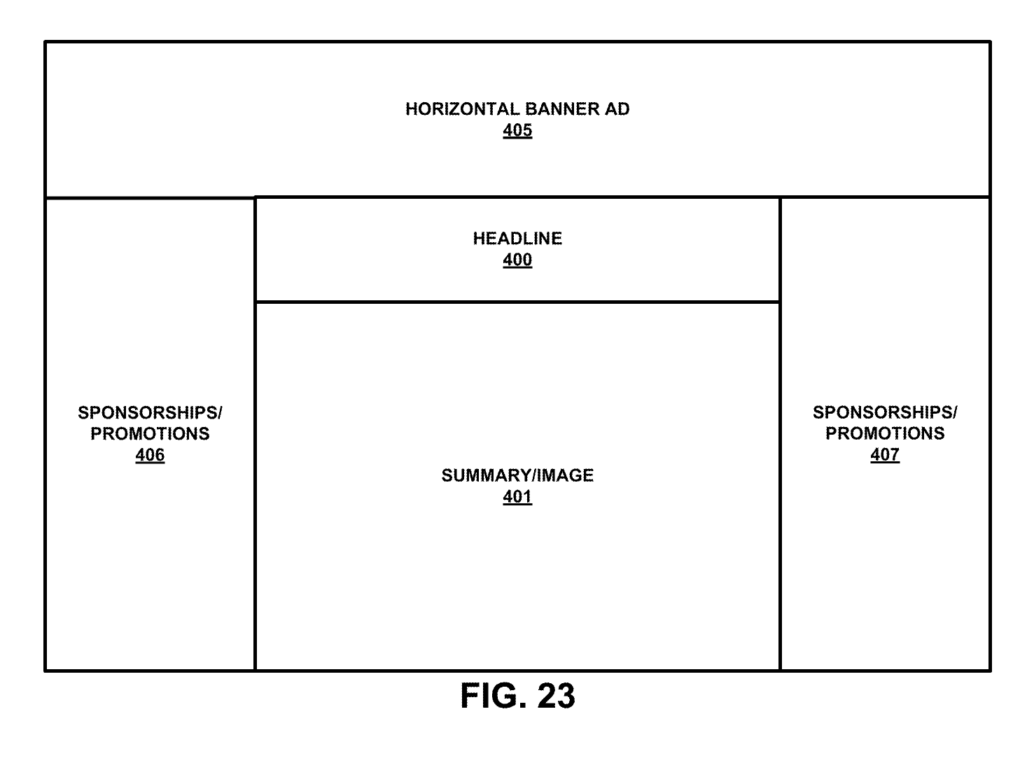

Both website server 150 and TV site 160 are structurally configured to facilitate a synchronized content display of journals for website subscriptions, topics for results of term searching, previews of unsubscribed websites and chronicles of links to saved bulletins. An example of a synchronized viewing is shown in FIG. 24. Specifically, a viewer may view a journal display or topic display of feeds 501 and 502 that were syndicated by www.espn.com in the morning of a particular day, and a journal display or topic display of feeds 503 and 504 that were syndicated by www.espn.com in the evening of that day. In this example, the viewer is presented with feeds 501 and 502 in the afternoon via web client 120 and then presented with feeds 503 and 504 in the evening via television 130. This ensures new feeds are also presented first with each viewing.

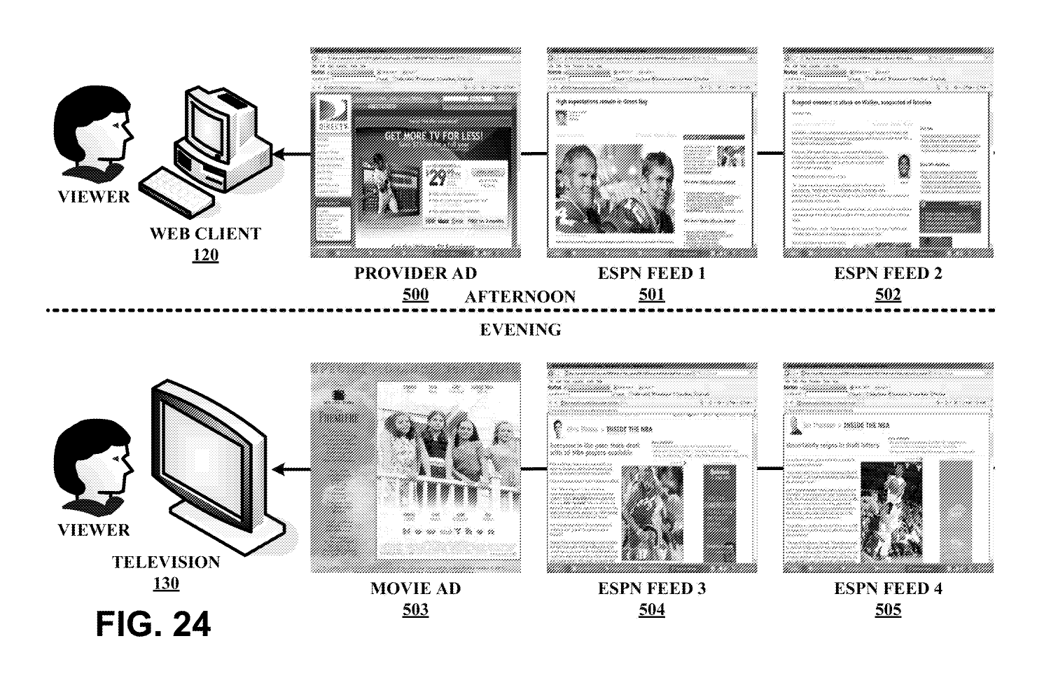

Ads 500 and 501 shown in FIG. 24 highlight various advertising schemes as shown in FIG. 25 for a subscriber of the television content. Specifically, a subscriber/web client 120 scheme involves the subscriber viewing third party banner ads 700 relative to bulletins 600. A nonsubscriber/web client 120 scheme involves the nonsubscriber first viewing a television content provider video advertisement/promotion 701 and followed by third party banner ads 700 relative to bulletins 600. A subscriber/television 130 scheme involves the subscriber first viewing a third party video advertisement/promotion 702 and followed by third party banner ads 700 relative to bulletins 600.

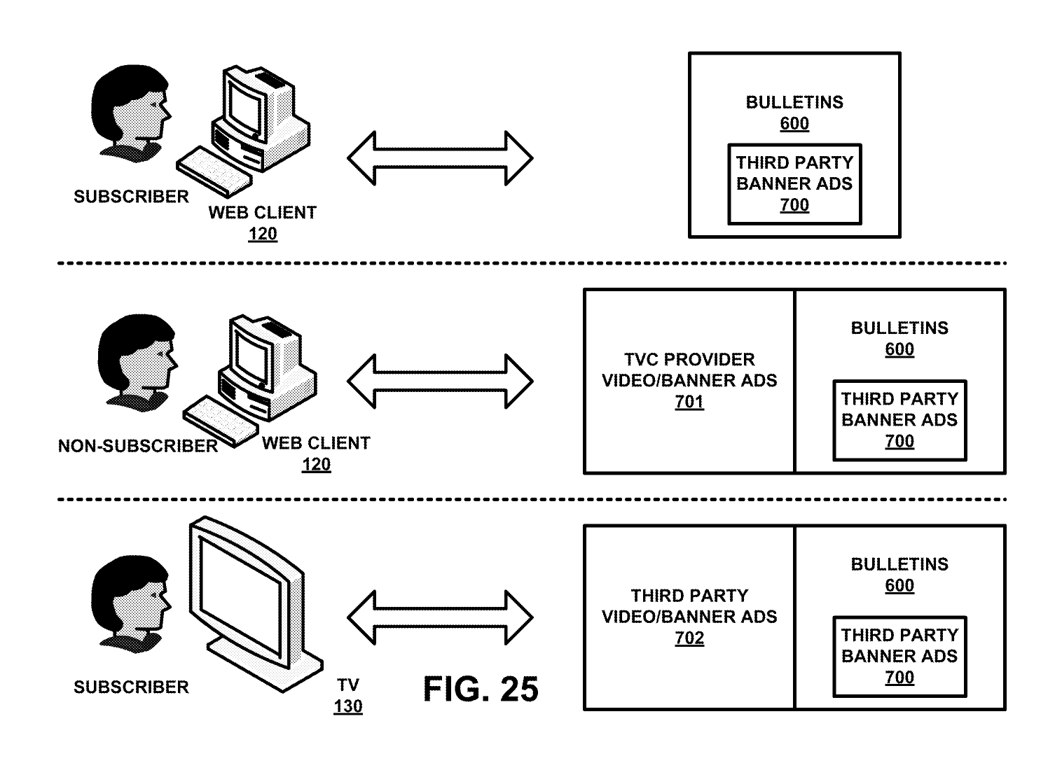

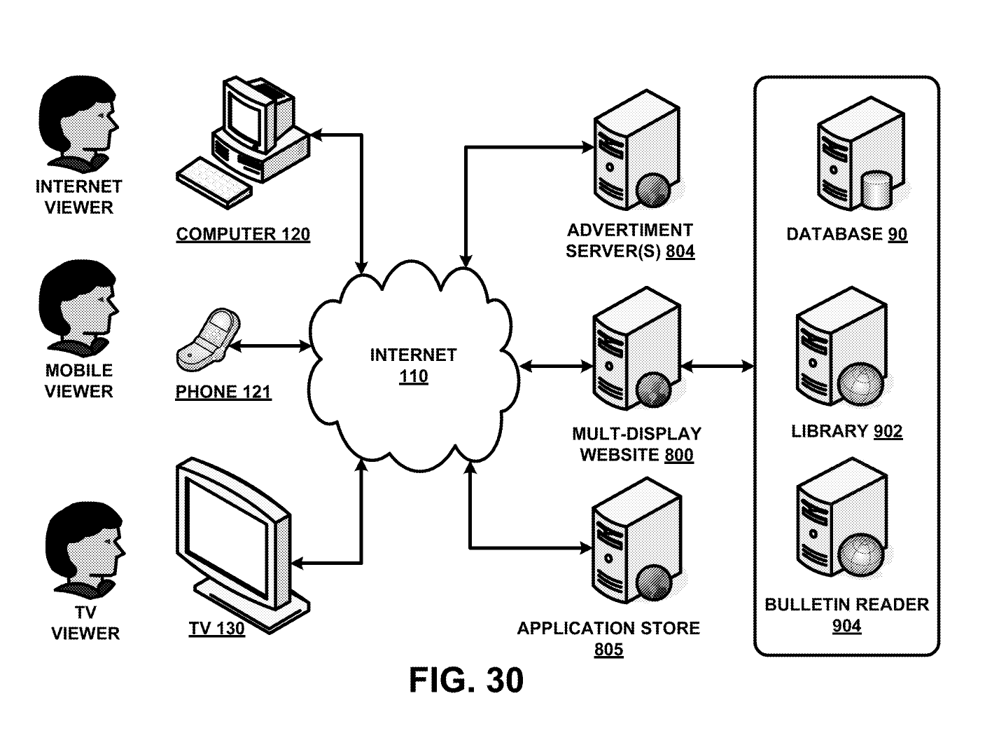

FIG. 26 illustrates a multi-display environment having a multi-display website 800 and a social network website 810 for displaying bulletins (e.g., bulletins shown in FIGS. 22 and 23) on a web client 120, a mobile phone 121 and a television 130 as managed by a viewer, particularly for a synchronized viewing of the bulletins. Multi-display website 800 is a version of website 150 shown in FIG. 8 having the additional capability of catalog management of its library as will be further explained herein in connection with FIG. 31.

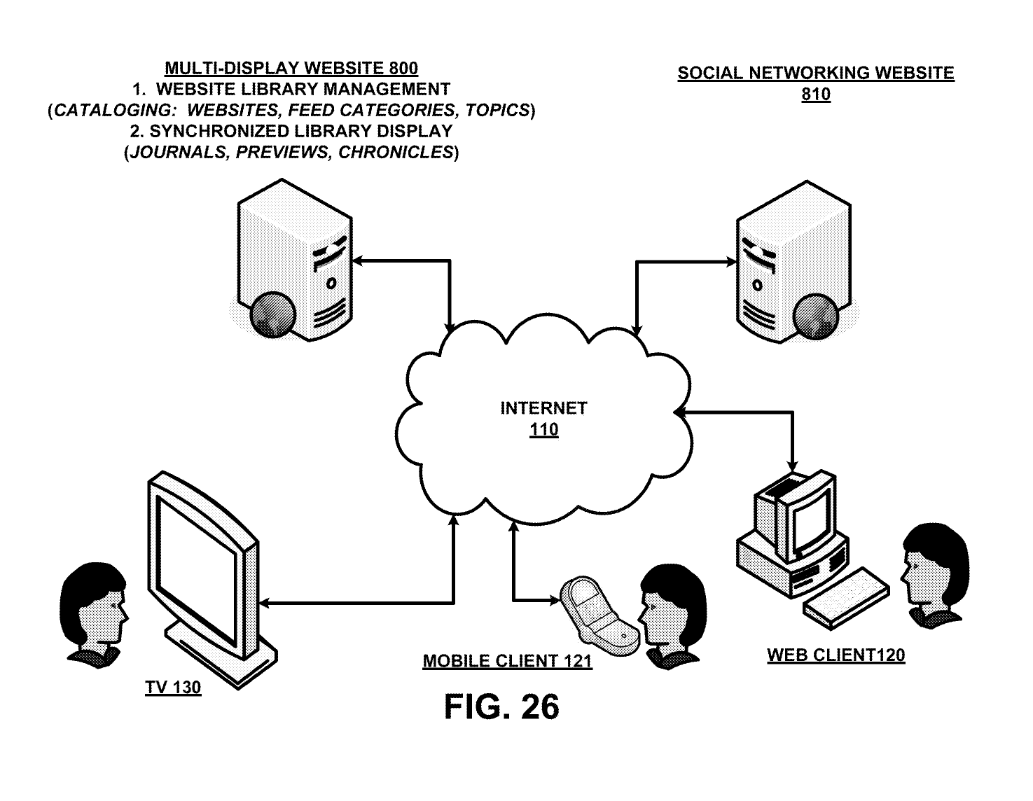

In general terms for television display, website 800 is interfaced with a television content broadcast system (e.g., DirecTV, Bright House, DISH, Comcast, Time Warner, AT&T, etc.) to facilitate a television display of the bulletins as individually managed by each subscriber of the cable/satellite television provider. For example, FIG. 27 illustrates a WFC aggregation system 900 accessible website 800 having a subscription account 901 associated with a subscription account 911 of a TFC digital receiver 910 to enable a viewer to view the bulletins from an aggregator library 902 either on a web client 120 via website 800, or on a television 130 via an WFC application 912 downloaded to the digital receiver 910. Upon seeing a particular bulletin on television 130, a subscriber may view a full link to the content of the bulletin by clinking on the headline link whereby application 912 retrieves the content in real-time from the corresponding website. For the TV display of the retrieved content, application 912 may display the content or store the content in a memory component of digital receiver of the television 130 for later access (e.g., storing the content in a hard drive for display view a DVR function of the digital receiver).

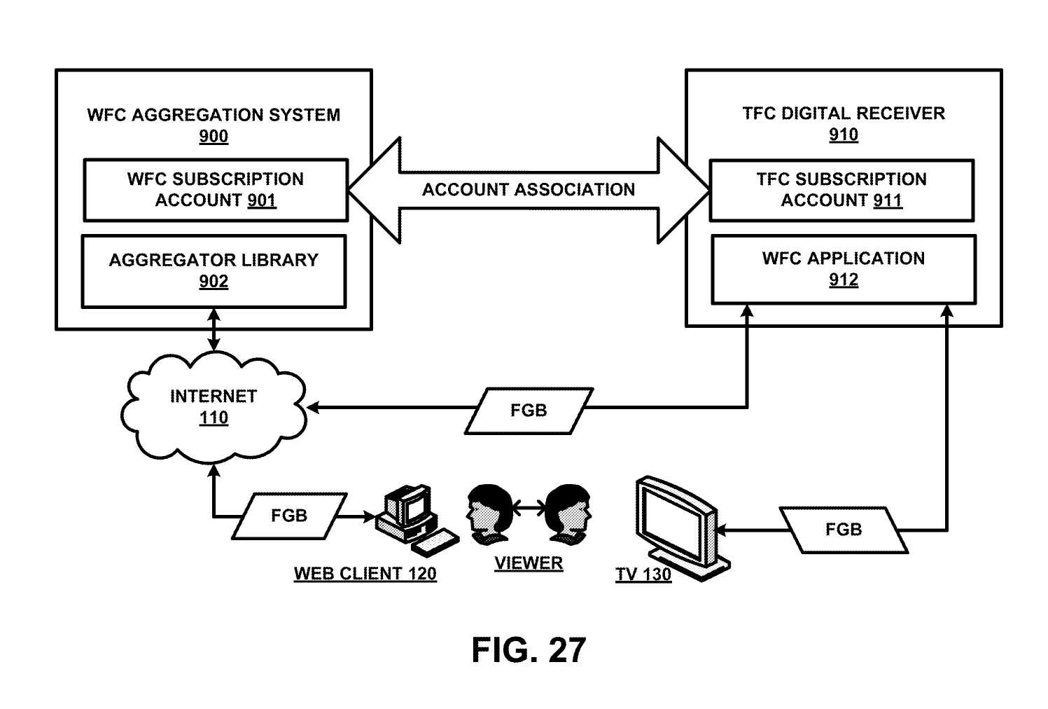

In general terms for a computer display, website 800 is interfaced with social networking website 810 (e.g., Facebook, Twitter, MySpace, Classmates.com, etc.) to facilitate a computer display of the bulletins as shared on social networking website 810 and as individually managed by each subscriber of social network website 810. For example, FIG. 28 illustrates WFC aggregation system 900 accessible via website 800 having a subscription account 901 associated with a subscription account 811 of social networking website 810 to enable a viewer to view the bulletins from an aggregator library 902 either on web client 120 via multi-display website 800 or a widget 822 on social networking website 810. Upon seeing a particular bulletin on social network website 810, a subscriber may view a full link to the content of the bulletin by clinking on the headline link whereby widget 822 retrieves the content in real-time from the corresponding website. Additionally, widget 822 facilitates a sharing of the bulletin by the subscriber with friends on the website 810.

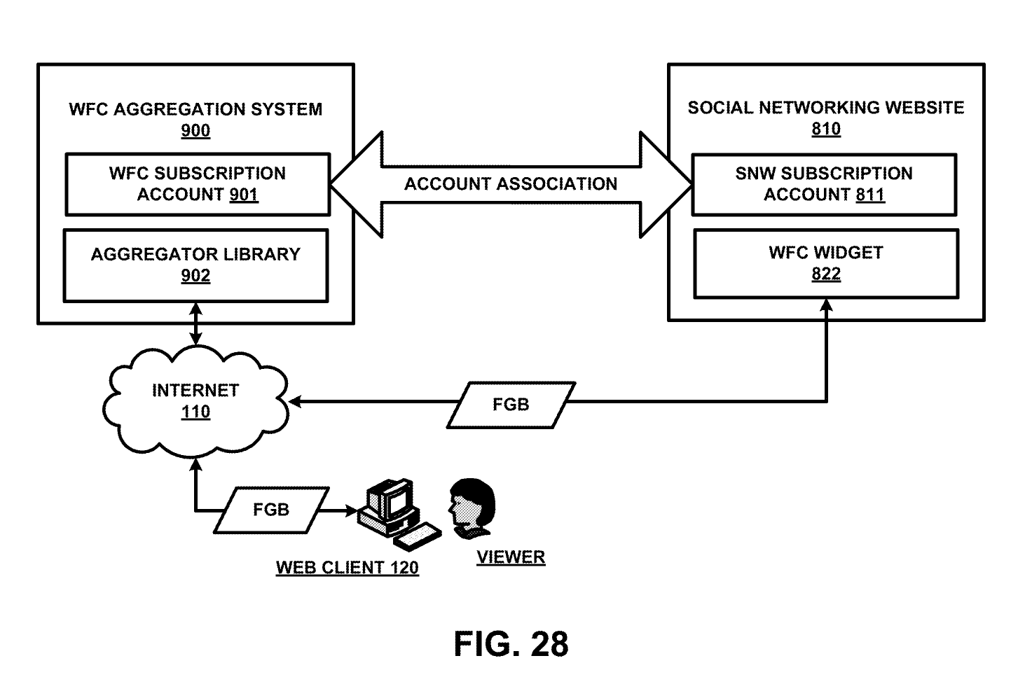

In general terms for a mobile phone display, website 800 is interfaced with a mobile network operator (e.g., Apple iPhone, Sprint, Verizon, AT&T, T-Mobile, etc.) to facilitate a mobile phone display of the bulletins as individually managed by each subscriber of the mobile network operator. For example, FIG. 29 illustrates WFC aggregation system 800 accessible via website 800 having a subscription account 901 associated with a subscription account 921 of a mobile network operator 920 to enable a viewer to view the bulletins from aggregator library 902 either on web client 120 via multi-display website 800 or on phone 121 via a WFC application 922 installed on the phone 121. Upon seeing a particular bulletin on phone 121, a subscriber may view a full link to the content of the bulletin by clinking on the headline link whereby application 922 retrieves the content in real-time from the corresponding website. For the mobile display of the retrieved content, application 922 may display the content or store the content in a memory component of phone 121 for later access.

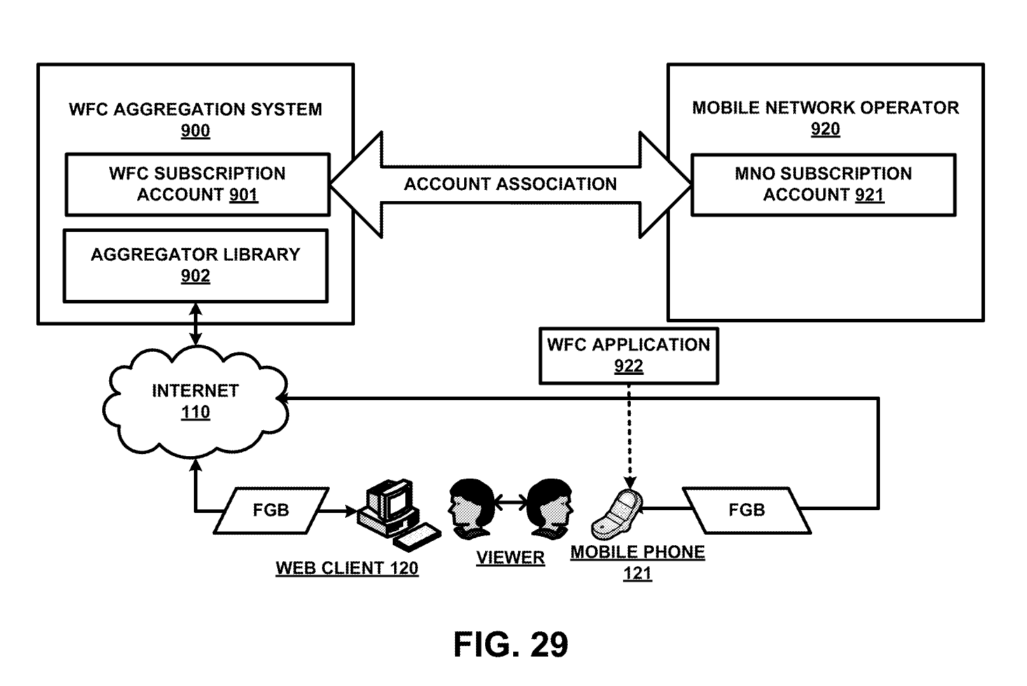

FIG. 30 illustrates system 900 (FIGS. 27-29) having an aggregator library 902, a database 903 and a bulletin reader 904 for managing a plurality of website feeds (e.g., 500K+ feeds). Multi-display website 800 facilitates a computer viewer via Internet 100 access to system 900 either directly by addressing website 800 or using a widget installed on a social networking website (not shown) whereby banner/video advertising from advertisement server(s) 804 will generate ad revenue from the computer viewer. Multi-display website 800 further facilitates subscribers of cable/satellite TV provider(s) and mobile network operator(s) to access system 900 via an application (not shown) downloaded from an application store 805 to a digital receiver (not shown) of the television 130 and mobile phone 121 at no cost or for a one-time subscription fee, and banner/video advertising from the advertisement server(s) 804 will generate ad revenue from the TV and mobile phones subscribers.

The bulletins are derived by reader 904 from a library 902 of 500K+ web feeds that is organized in a hierarchy that (1) enables a viewer management of a personal portfolio of website feeds selected from the library 902 by means of website class cataloging, feed category cataloging and topic cataloging, and (2) synchronizes viewing between the computer 120, the television 130 and mobile phone 121 to ensure new web feed content is being presented at each viewing.

Specifically, for the cataloging, FIG. 31 illustrates a web genre tree 950 branching from the top down through six (6) levels. The first level is a root level having a number W of root nodes 951, where W>1, with root nodes 951 encompassing a general description of all websites within tree 950. For example, root nodes 951 may encompass a media root node, a government root node, a sports root node, an education root node, an entertainment root node, a consumer root node, a video/photos root node, a business/financial root node, a health/fitness root node, a science/technology root node, a special interest rood node and a personal feeds root node.

The second level is a geographic division level for each root node that divides websites under an associated root node by a geographic location of the subscriber in terms of local websites 952(1) (e.g., a state), national websites 952(2) and international websites 952(3).

The third level is a web class level having a number X of web class nodes 953, where X>1, with web class nodes 953 encompassing specific description of each website listed within an associated root node 951. For example, for a media root node, the website classes may be television stations, newspapers, radio stations, publications and media domains whereby all websites listed under the media root node is assigned to one of the website classes.

The fourth level is a feed category level having a number Y of feed categories 954, where Y≧1, with feed categories encompassing categories explicitly or implicitly stated on an associated website. For example, USATODAY.com has feed categories including news, sports, tech, travel, money, life, weather and other.

The fifth level is a feed subcategory level having a number Z of feed categories 955, where Z≧1, with feed subcategories encompassing a detailed description or grouping of each feed within the category listing of an associated website. For example, with the sports category of USATODAY, the NFL feed and the college football feed may be assigned to a football subcategory. Also by example, with the sports category of USATODAY, the NFL feed, the NBA feed, the AL baseball feed, the NL baseball need and the hockey feed may be assigned to professional sports subcategory while the college football feed and the college basketball feeds may be assigned to the collegiate sports subcategory.

In managing one's account with tree 950, a subscriber will be provided with three (3) catalog mode of navigating tree 950. The first catalog mode is a website class mode encompassing a sequential navigation of nodes 951-952-953-954-955. This website mode is premised on the subscriber's desire to view the all of the feeds of a particular website of interest. For example, the subscriber may desire to view all of the feeds offered by the Wall Street Journal.

The second catalog mode is a feed category mode encompassing a sequential navigation of nodes 951-952-954-955. This feed category mode is premised on the subscriber's desire to view a particular feed category of interest for each website within a particular genre. For example, the subscriber may desire to view diabetes feeds all websites within the health/fitness genre having such a feed.

The third catalog mode is a topic mode encompassing a navigation of the website class mode or feed category mode based on a particular topic of interest. This topic mode is premised on the subscriber's desire to view the topic of interest within bulletins derived from all websites within a particular genre or genre(s) or a particular website class or classes, or to view the topic of interest within bulletins derived from one or more feed categories or one or more feed subcategories. For example, the subscriber may desire to view bulletin's including the term “health care” for all websites within the government genre or all websites within an executive branch website class within the government genre. Also by example, the subscriber may desire to view bulletins including the term “Nicholas Cage” for a movie news feed category or an actor feed subcategory of the movie news feed category.

Referring still to FIG. 31, an alternative embodiment of website genre tree 950 involves a switching of geographic level 952 with website class 953. A second alternative involves a removal of geographic level 952 from tree 950 where tree 950 may itself have a geographic filter (e.g., only websites in the United States).

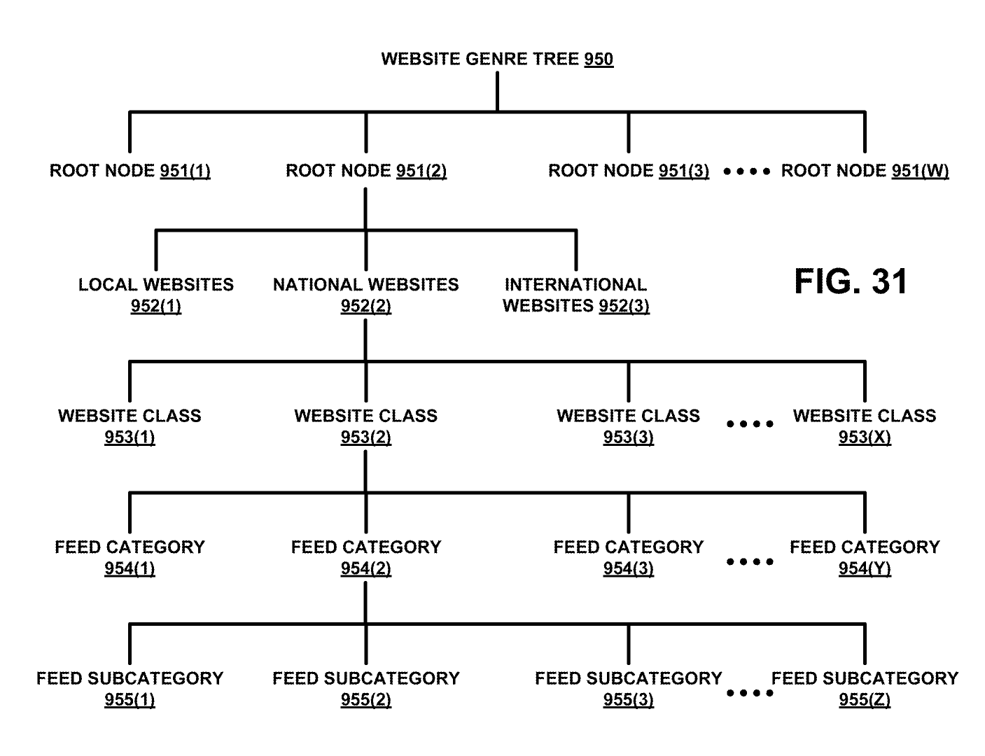

FIG. 32 illustrates a flowchart 1000 representative of a method of a television content management of a television display of web feed content. Flowchart 1000 is premised on managing web feed content for television display for a viewer that is responsive to (1) the viewer viewing a particular television program (e.g., news, a sitcom or a movie), (2) a particular television program being stored within a recording component of the television or associated receiver (e.g., a movie being stored in a DVR of a receiver), (3) a particular television program being scheduled for storage within the recording component of the television or associated receiver (e.g., a movie being listed for future storage within a DVR of a receiver), (4) a particular television program being streamed from a centralized server or content delivery network to the television and/or (5) a particular television program that is stored on a centralized server or content delivery network for distribution to the particular user's television. This would allow linking to a DVR, an on-demand service and online services. In particular, IP-based web content (e.g., video) may be viewed on the TV through the FeedGazer system.

Specifically, a stage S1001 of flowchart 1000 encompasses an identification of a celebrity within the television program. In one exemplary embodiment, information about the television program within an electronic program guide is parsed to identify each celebrity. Upon identification of the celebrity, content about the identified celebrity is automatically retrieved and/or generated for the viewer. Alternatively, the content about the identified celebrity is retrieved and/or generated for the viewer if the viewer has specified an interest in the celebrity (e.g., a selection of the celebrity via a website that implements part of the present system).

A stage S1002 of flowchart 1000 thereafter encompasses an interactive provision of celebrity content for each celebrity identified during stage S1001. In one exemplary embodiment, a web page containing a biography of a celebrity is interactively provided to the viewer. An example of such a biography may be found at the Internet Movie Database (www.imbd.com). In another exemplary embodiment, additional programming including the celebrity is interactively provided to the viewer. An example of such additional programming may be additional movies starring the celebrity within the electronic program guide, the DVR, the on-demand service and/or the online services. Linking to other assets that are immediately available to the consumer on the television is a compelling feature and shows value to both the distributor and consumer. For example, an electronic program guide ID (TMS) from the actual program as known in the art may be linked to other assets that are available that can be tied to the same ID (e.g., all things related to the show including, but not limited to actors, directors, other episodes, etc.). These IDs are being incorporated into metadata feeds for on-demand services and online services as would be appreciated by those having ordinary skill in the art.

In yet another exemplary embodiment, bulletins in accordance with FIGS. 21 and 22 herein may be interactively provided to the viewer. For example, the celebrity may be the subject of a search of web feed content within the Entertainment genre (FIG. 18) and each search result may be used to generate a corresponding bulletin.

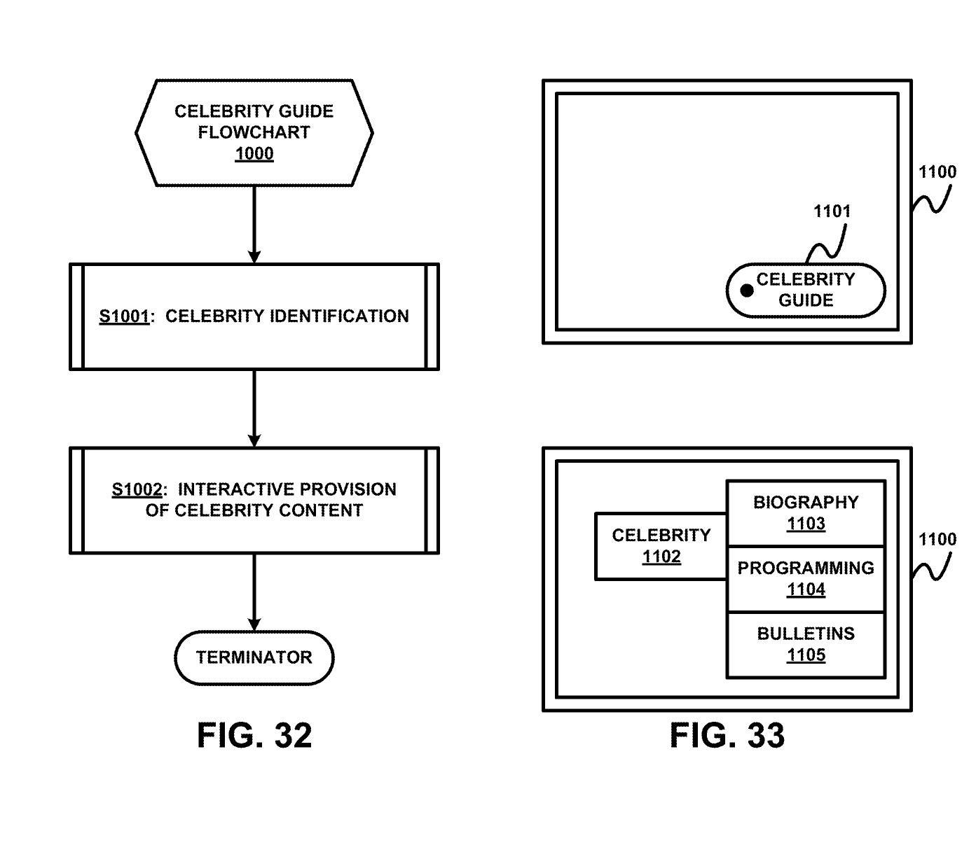

FIG. 33 illustrates an exemplary example of an implementation flowchart 1000. Specifically, a celebrity guide 1101 may be displayed on a television 1100 in response to (1) the viewer viewing a television program (e.g., news, a sitcom or a movie), (2) a television program being stored within a recording component of the television or associated receiver (e.g., a movie being stored in a DVR of a receiver), and/or (3) a television program being scheduled for storage within the recording component of the television or associated receiver (e.g., a movie being listed for future storage within a DVR of a receiver). The display of celebrity guide 1101 may be interactively controlled by the viewer or automatic upon the viewer tuning into to a specific channel or television program.

Upon an interactive activation of celebrity guide 1101, the viewer is presented with a name 1102 of the celebrity, an interactive biography 1103 of the celebrity, an interactive programming 1104 associated with the celebrity, and an interactive bulletin reader 1105. For example, while a viewer is watching an episode of “Star Trek,” the viewer may activate celebrity guide 1101 to obtain a biography of William Shatner (e.g., an IMBD webpage for William Shatner), to view other programming within the electronic program guide having William Shatner (e.g., an upcoming episode of Boston Legal or T J Hooker), and to view bulletins containing William Shatner (e.g., RSS feeds of William Shatner from websites including People.com, E!Online, TV Guide, etc.).

As known in the art, servers include processors and memories. For the purposes of the present system, the term “processor” as used herein is broadly defined as one or more processing units of any type for performing all arithmetic and logical operations and for decoding and executing all instructions related to facilitating an implementation of the present system. Additionally, the term “memory” as used herein is broadly defined as encompassing any and all program and data storage in the form of computer readable media of any type.

While the embodiments of the system disclosed herein are presently considered to be preferred, various changes and modifications can be made without departing from the spirit and scope of the present system. The scope of the system is indicated in the appended claims, and all changes that come within the meaning and range of equivalents are intended to be embraced therein.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method of displaying web feed content on television, the method comprising:
operating a web feed content aggregation system for retrieving syndicated web feed content on a web subscription basis,
operating a television content broadcast system for broadcasting television content on a television subscription basis;
interfacing the web feed content aggregation system and the television content broadcast system based on an account association of a web feed content aggregation subscription account and a television content broadcast subscription account; and
facilitating content management for a television display of the web feed content as a function of (1) the account association of the web feed content aggregation subscription account and the television content broadcast subscription account and (2) a content factor selected from the content factor set consisting of:
a person associated with particular television content associated with the television subscription;
a series identifier associated with particular television content associated with the television subscription;
a subject of a search of web feed content, where the search is associated with a web subscription account.

2. The method of claim 1, wherein the content factor is a person associated with particular television content associated with the television subscription, and the person is an actor in the particular television content.

3. The method of claim 1, wherein the content factor is a person associated with particular television content associated with the television subscription, and the person is a director of the particular television content.

4. The method of claim 1, wherein:
the content factor is either a person associated with particular television content associated with the television subscription, or a series identifier associated with particular television content associated with the television subscription, and
the particular television content is being viewed by a user at about the same time that the web feed content is selected for display.

5. The method of claim 4, wherein the selection and display of web feed content is automatic.

6. The method of claim 1, wherein:
the content factor is either a person associated with particular television content associated with the television subscription, or a series identifier associated with particular television content associated with the television subscription, and
the particular television content is stored by a digital video recorder associated with the television subscription.

7. The method of claim 1, wherein:
the content factor is either a person associated with particular television content associated with the television subscription, or a series identifier associated with particular television content associated with the television subscription, and
the particular television content is scheduled for recording by a device associated with the television subscription.

8. The method of claim 1, wherein:
the content factor is a person associated with particular television content associated with the television subscription, and
the web feed content is automatically selected to be a biography of the person.

9. The method of claim 1, wherein:
the content factor is a person associated with particular television content associated with the television subscription, and
the web feed content is automatically selected to be additional television content associated with the person.

10. The method of claim 1, wherein:
the content factor is a person associated with particular television content associated with the television subscription, and
the web feed content is automatically selected to be a feed of bulletins associated with the person.
